(19) United States
(12) Patent Application Publication
(10) Pub. No.: US 2023/0236147 A1
(43) Pub. Date: Jul. 27, 2023

(54) SENSORS AND SYSTEMS BASED ON FIELD-EFFECT TRANSISTORS, METHODS OF PREPARATION AND DEVICES FOR THEIR OPERATION

(71) Applicants: Jose Maria PICCININI, La Plata Prov. de Buenos Aires (AR); GISENS BIOTECH SA, Ciudad Autónoma de Buenos Aires (AR); CONSEJO NACIONAL DE INVESTIGACIONES CIENTÍFICAS Y TÉCNICAS (CONICET), Ciudad Autónoma de Buenos Aires (AR); UNIVERSIDAD NACIONAL DE LA PLATA (UNLP), La Plata, Prov. de Buenos Aires (AR)

(72) Inventors: Jose Maria PICCININI, Berazategui, Province de Buenos Aires (AR); Omar AZZARONI, La Plata, Province de Buenos Aires (AR); Esteban PICCININI, La Plata, Province de Buenos Aires (AR); Waldemar Alejandro MARMISOLLE, La Plata, Province de Buenos Aires (AR); Juan Alejandro ALLEGRETTO, La Plata, Province de Buenos Aires (AR); Juliana SCOTTO, Berazategui, Province de Buenos Aires (AR); Agustín Lorenzo CANTILLO, La Plata, Province de Buenos Aires (AR); Gonzalo Eduardo FENOY, La Plata, Province de Buenos Aires (AR)

(21) Appl. No.: 17/927,841

(22) PCT Filed: May 27, 2021
(86) PCT No.: PCT/IB2021/054656

§ 371 Date: Nov. 25, 2022

Related U.S. Application Data
(60) Provisional application No. 63/030,558, filed on May 27, 2020.

(51) Int. Cl. G01N 27/414; B82Y 15/00

(52) U.S. Cl. CPC G01N 27/4146; G01N 27/4145; B82Y 15/00

(57) ABSTRACT

A sensor comprising a field-effect transistor of a semiconducting material in two-dimensional nanosheets having an interfacial nanoarchitecture comprising a recognition element, a structural element and a polymeric coating, a gate electrode of the transistor being coplanar with a drain electrode and a source electrode of the transistor; a system using the sensor and methods of preparation and use thereof. The disclosed sensor has increased stability and an interfacial nanoarchitecture suitable for the immobilization of a broad number of recognition elements without loss of their biological activity.

### TECHNICAL FIELD

The present invention generally relates to the field of sensing devices and methods for quantifying analytes. Specifically, the present invention relates to sensors based on field-effect transistors comprising semiconducting two-dimensional nanosheets, methods of preparation thereof and methods for determining the concentrations of target analytes in a liquid sample, such as a biological sample.

### BACKGROUND

Electrochemical sensors have become an important topic in the field of applied research as well as in medical and biological applications, due to their advantages over classical analytical methods including ease of operation, low cost and compact size. Biosensors are a subgroup of chemical sensors comprising biological host molecules as recognition elements coupled to a chemical or physical transducer. Highly selective biosensors present a powerful tool for real-time measurement of a variety of analytes for a wide range of applications such as food safety, environmental monitoring, drug screening and diagnosis.

These sensors may comprise recognition elements, capable of specifically and selectively detecting or measuring the amount of a given analyte. Among these recognition elements are molecules with a biological function, such as enzymes, antibodies, aptamers and the like, which provide an advantageous alternative to the detection of specific analytes, owing to their availability and biocompatibility. In particular, the variety of enzymes and enzymatic cascade reactions makes these recognition elements applicable to a wide range of analytes.

Two-dimensional (2D) semiconducting materials such as graphene, hexagonal boron nitride (h-BN) and black phosphorus have been attracting increasing interest during the last years due to their physicochemical, optical and electronic properties. The use of these materials for diagnostics applications is promoting overcome the current boundaries of sensitivity, response time and sample processing. In particular, graphene, a sheet of hexagonally arranged carbon atoms, is one of the most attractive 2D materials for biosensing devices due to its high conductivity, large specific area and great chemical stability.

Biosensors comprising graphene transistors are described in the patent literature, such as in US 2013/306934 A1, US2016/025675 A1, US 2016/334399 A1 and WO 2019/231224 A1. While graphene has distinct conductive properties that provide an advantageous detection sensitivity, the materials often present high heterogeneity, resulting in variable physical properties such as transconductance, minimal current, maximal resistance and threshold voltage. This results in decreased repeatability of sensor fabrication methods and lower sensor stability, features that must be improved for the use of graphene transistors as reliable sensors in medical diagnostics. Further disadvantages of the devices of the prior art are: i) the lack of a biosensor based on liquid-gated reduced graphene oxide field-effect transistors (rGO-FETs) having an arrangement suitable for detection using small volume samples; ii) the lack of a biosensor based on rGO-FETs with a gate electrode adapted for stable and reproducible measurements; iii) the lack of a biosensor based on rGO-FETs comprising a nanoarchitecture suitable for the immobilization of a broad number of recognition elements without loss of their biological activity and having anti-fouling properties; iv) the lack of a biosensor based on rGO-FETs comprising a highly stable nanoarchitecture suitable for the non-covalent immobilization of recognition elements to the semiconducting transistor channel; v) the lack of a method of preparation for multiple and coplanar rGO-FETs, for multiple analyte diagnostics; vi) the lack of a rGO-FET suitable for being post-modified with microfluidic layers for Lab-on-a-Chip (LoC) measurements.

Lastly, direct covalent attachment of recognition elements to 2D semiconducting materials induces lattice defects that hinder charge transport and, thus, impair the signal transduction. For example, graphene covalent functionalization is accomplished using “oxidative” defects, such as carboxylates or hydroxyl groups (see, e.g., S. Niyogi, E. Bekyarova, M. E. Itkis, H. Zhang, K. Shepperd, J. Hicks, M. Sprinkle, C. Berger, C. N. Lau, W. A. Deheer, E. H. Conrad, R. C. Haddon, Spectroscopy of covalently functionalized graphene, Nano Lett. 10 (2010) 4061-4066. https://doi.org/10.1021/n11021128). The higher the degree of defects present, the less charge transport and sensor sensitivity will be observed in a biosensing device. Therefore, it would be advantageous that the attachment of recognition elements to 2D semiconducting materials for biosensing devices is done by non-covalent, i.e. supramolecular approaches.

There is therefore a need to provide a sensor based on transistors of 2D semiconducting materials having improved reproducibility, increased stability and sensitivity that requires only a small volume of biological sample and that is suitable for multiple analyte (multiplex) diagnostics and post-modification with microfluidic layers for LoC measurements. In addition, there is a need to provide sensors comprising a nanoarchitecture suitable for the immobilization of a large number of recognition elements without loss of their biological activity and having antifouling properties, wherein the nanoarchitecture further amplifies the specific sensor signal. Furthermore, there is a need to provide sensors comprising a highly stable nanoarchitecture suitable for the non-covalent immobilization of recognition elements to the semiconducting transistor channel. Lastly, there is a need to provide a portable system for measuring the concentration of a specific analyte in a biological sample using the provided sensor.

### SUMMARY

The present invention offers a solution to the shortcomings of the prior art by providing a sensor of increased stability, obtained by a pre-treatment of graphene oxide sheets in solution. In addition, the gate, source and drain electrodes of the sensor are coplanar, with the source and drain electrodes being interdigitated. The sensor is provided with an interfacial nanoarchitecture suitable for the immobilization of a broad number of recognition elements without loss of their biological activity. This nanoarchitecture also amplifies the specific sensor signal. Further, the sensor is provided with a polymeric coating that allows for the elimination of signals that are non-specific to a target analyte, such as those due to ionic strength, temperature, interferents, etc.

With this configuration, measurements for the detection and quantification of molecules of clinical interest can be achieved in sample volumes as low as 1 μL, in a small and simpler-to-use sensor.

Therefore, in a first aspect, the invention provides a sensor comprising a field-effect transistor of a semiconducting material, the material being in the form of two-dimensional nanosheets, comprising a source electrode, a drain electrode and a gate electrode, and an interfacial nanoarchitecture comprising a recognition element, a structural element and a polymeric coating, wherein the gate electrode of the transistor is coplanar with the drain electrode and the source electrode of the transistor.

In preferred embodiments of the invention, the material is selected from graphene, reduced graphene oxide, few-layer graphene, twisted bilayer graphene, conducting polymers, transition metal dichalcogenides, black phosphorous, and hexagonal boron nitride. In a further preferred embodiment, the material is reduced graphene oxide (rGO).

Optionally, the sensor comprises a second field-effect transistor comprising a polymeric coating. Further, the sensor may optionally comprise more than two field-effect transistors on the same substrate. Preferably, the field-effect transistors are reduced graphene oxide field-effect transistors.

In an embodiment, the recognition element is located at a distance up to 100 nm from a semiconducting material surface of the transistor. The recognition element is held immobilized by the structural element of the interfacial nanoarchitecture. The structural element is attached to a semiconducting two-dimensional nanosheet by one or more supramolecular binding-points. In a preferred embodiment, the semiconducting material is reduced graphene oxide.

Preferably, the source and drain electrodes of the transistor are interdigitated electrodes. In preferred embodiments, the electrodes are made of a conductive material selected from gold, platinum, graphite, silver, conducting polymers and combinations thereof.

In a preferred embodiment, the gate electrode is made of a conductive material selected from gold, platinum, graphite, silver, conducting polymers and combinations thereof and comprises a coating of Ag/AgCl.

In preferred embodiments, the recognition element is a substance selected from an enzyme, an antibody, an aptamer, clustered regularly interspaced short palindromic repeats (CRISPR) with a CRISPR associated protein (Cas), an ion-selective molecule, a high-affinity binding-protein and combinations thereof. Preferably, the substance is selected from urease, acetylcholinesterase, creatinine deiminase, streptavidin, avidin, valinomycin, tridodecylamine, an antibody or aptamer capable of binding an analyte selected from the group consisting of ferritin, Interleukin 6 (IL-6), SARS-CoV-2 spike protein, SARS-CoV-2 nucleocapsid (N) protein, follicle-stimulating hormone (FSH), anti-Müllerian hormone (AMH), estradiol, Luteinizing hormone (LH), fragments thereof, and modified fragments thereof.

In a preferred embodiment, the structural element comprises a substance selected from a polyelectrolyte, a polymer, a cross-linker, a heterofunctional nanoscaffold and combinations thereof. Preferably, the heterofunctional nanoscaffold comprises a substance selected from vinylsulfonated-polyamine (VS-PA), streptavidin, avidin and combinations thereof.

Preferably, the polymeric coating comprises a substance selected from polyethylene-glycol (PEG), a polyethylene-glycol derivatized polymer, a substance comprising polyethylene-glycol, a zwitterionic polymer, a fluoropolymer, a hydrogel and combinations thereof.

In a second aspect, the invention provides a system comprising:
a sensor according to the first aspect and a receptacle for a liquid sample, such as a biological sample
a power source connected to the sensor for establishing a voltage between the gate, drain and source electrodes of the sensor,
processing means for processing data connected to the sensor,
wherein the processing means for processing data comprise calculating means for calculating a concentration of a target analyte in the biological sample.

Preferably, the calculating means for calculating the concentration comprise an algorithm for processing a sensor response and/or eliminating means for eliminating interfering signals.

The system preferably comprises an interface for displaying the value of the concentration of the target analyte in the biological sample.

In a third aspect, the invention provides a method for preparing a sensor comprising field-effect transistors, the method comprising the steps of:
providing a solution comprising a semiconducting material in two-dimensional nanosheets,
providing a field-effect transistor comprising a substrate and interdigitated drain and source electrodes,
depositing the solution onto a substrate surface,
providing a gate electrode coplanar with the interdigitated drain and source electrodes, and
providing the sensor surface with an interfacial nanoarchitecture comprising a recognition element, a structural element and a polymeric coating.

In preferred embodiments of the third aspect, the invention provides a method for preparing a sensor comprising reduced graphene oxide field-effect transistors, the method comprising the steps of:
providing a graphene oxide solution,
providing a field-effect transistor comprising a substrate and interdigitated drain and source electrodes,
depositing graphene oxide onto a substrate surface and reducing the graphene oxide,
providing a gate electrode coplanar with the interdigitated drain and source electrodes, and
providing the sensor surface with an interfacial nanoarchitecture comprising a recognition element, a structural element and a polymeric coating.

In a fourth aspect, the invention provides a method for detecting an analyte in a biological sample using the system according to the second aspect, comprising the steps of:
applying a voltage to a channel region through a gate electrode of a sensor according to the first aspect,
contacting the sensor with the liquid sample,
measuring a sensor response before and after the biosensor is brought in contact with the sample, and,
calculating the concentration of the biological sample from the sensor response.

The invention further provides a method for indirectly detecting an analyte in a liquid sample using the system according to the second aspect, comprising the steps of:
contacting a sensor according to the first aspect with the liquid sample,
contacting the sensor with a solution comprising an enzyme-labeled secondary recognition element capable of binding to the target analyte,
contacting the biosensor with a solution comprising an enzyme substrate,
detecting the product of the reaction between the enzyme and the enzyme substrate, whereby the concentration of the analyte in the liquid sample is calculated indirectly.

In preferred embodiments, the enzyme-labeled secondary recognition element is dissolved in the liquid sample.

In preferred embodiments of all the aspects below, the nanoarchitechture is such that a recognition element is located at a distance up to 100 nm from a semiconducting material surface of the transistor. Preferably, a structural element is attached to the semiconducting material by one or more supramolecular binding-points.

In a fifth aspect, the invention provides a method for characterizing a recognition element by studying its interactions with ligands using the system according to the second aspect, the method comprising the steps of:
contacting the recognition element with at least one ligand;
contacting the recognition element with at least one additional ligand, the biomolecule or the additional ligand being bound to a sensor surface; and
determining an interaction by detecting a change in the field-effect properties of the sensor.

In preferred embodiments of this fifth aspect, the method comprises the steps of:
a) binding the recognition element to the sensor,
b) contacting at least two ligands with the biomolecule bound to the sensor, and
c) after contacting each ligand with the sensor surface to which the recognition element is bound, determining an interaction of the respective ligand with the recognition element by detecting a change in the field-effect properties of the sensor.

In other preferred embodiments of this fifth aspect, the method comprises the steps of:
a) binding a ligand to the sensor,
b) contacting the recognition element with the ligand bound to the sensor,
c) contacting one or more additional ligands with the recognition element bound to the sensor, and
d) after the contact of each additional ligand with the sensor surface to which the recognition element is bound, determining the interaction of the respective ligand with the recognition element by detecting a change in the field-effect properties of the sensor.

In a sixth aspect, the invention provides a method for preparing heterofunctional nanoscaffolds attached to a semiconducting two-dimensional nanosheet surface by one or more supramolecular binding-points, the method comprising the steps of:
contacting the semiconducting nanosheet surface to a supramolecular-covalent crosslinker that adsorbs supramolecularly onto two-dimensional nanosheet surface, thereby obtaining a modified surface sensor,
contacting the modified surface sensor to a polymer containing primary amines or a biomolecule containing primary amines that reacts covalently with the crosslinker; and
for the case of using of a polymer containing primary amines, contacting the modified surface sensor with a divinyl sulfone solution.

In preferred embodiments, the polymer containing primary amines is selected from polyallylamine, polyethyleneimine, polybutenylamine, polylysine and polyarginine, and copolymers thereof.

### BRIEF DESCRIPTION OF THE FIGURES

FIG. 1 shows a schematic representation of the system provided by the present invention.

FIG. 2 shows a schematic illustration of the design for both a) the cover and b) the base of the holding cell for the FET and interdigitated electrodes.

FIG. 3 shows a schematic representation of a field-effect transistor provided by the present invention.

FIG. 4 shows a schematic representation of single-FET, dual-FET and multi-FET configurations of the field-effect transistor provided by the present invention.

FIG. 5 shows a flow diagram of the measurement and analysis module of the system provided by the present invention.

FIG. 6 shows a schematic representation of the basic analog circuits for both the single-FET and dual-FET configurations.

FIG. 7 shows a schematic representation of the analog module of the measurement and analysis module of the system provided by the present invention.

FIG. 8 shows a schematic representation of a detailed analog circuit of the system provided by the present invention.

FIG. 9 shows a diagram illustrating the design of the FETmeter circuit of a multi-plex unit.

FIGS. 10 to 13 represent different voltage functions that are applied to the field-effect transistor provided by the present invention.

FIG. 14 shows two schematic diagrams a) and b) illustrating the detection process when a FET sensor modified with a nanoarchitecture comprising the recognition element is brought into contact with the sample that contains the target analyte, according to alternative embodiments.

FIG. 15 shows a scanning electron microscopy (SEM) image of the rGO-FET prepared according to an exemplary embodiment.

FIG. 16 shows an X-ray photoelectron spectroscopy spectrum of the chemically reduced rGO prepared according to an exemplary embodiment.

FIG. 17 shows a plot representing drain-source current as a function of the gate-source potential for a rGO-FET prepared as described in Example 1.

FIG. 18 shows a plot representing drain-source current as a function of gate-source potential for a rGO-FET prepared as described in Example 1 and measured in solutions of different pH values.

FIG. 19 shows a plot of the Dirac point voltage (ΔVᵢ) as a function of pH value for three rGO-FETs (devices 1, 2 and 3) prepared according to Example 1 with its respective linear fit.

FIG. 20 shows a) thickness and b) contact angle evolution after PA anchoring on PBSE/rGO surfaces and changes after DVS functionalization (VS-PA) and mannosylation; The error bars represent the 95% confidence interval; c) shows Raman spectra for bulk modification of PEI 750 kDa with DVS.

FIG. 21 shows a schematic representation of a) covalent binding of small motifs to VS-PEI substrates and b) the associated Contact angle changes; the error bars represent the 95% confidence interval.

FIG. 22 shows a) SPR sensorgrams for the PEGylation of VS-PA modified graphene sensors and b) the change of θ_{SPR} as a function of the number of injections determined in the buffer media for VS-PEI (solid bars) and PBSE/rGO (patterned bars).

FIG. 23 shows a) thickness and b) contact angle changes after each modification step of PBSE/rGO substrates; error bars represent the 95% confidence interval.

FIG. 24 shows a) structural stability of PEGylated ConA/VS-PEI scaffold seen as thickness changes after incubation in Triton X-100; the error bars represent the 95% confidence interval, b) antifouling capacity of PEGylated scaffold compared to rGO and PBSE substrates and c) steady-state θ_{SPR} response as a function of glucose oxidase (GOx) concentration for VS-PEI scaffolds modified with ConA, PEG-NH₂ and blocked with ETA.

FIG. 25 shows a) transfer characteristic curves for one GFET before and after each modification step for the preparation of VS-PA and its binding to Con A, PEGylation and blocking, b) transconductance as a function of V_{G} for the characteristic transfer curves shown in a), c) shift of the charge neutrality point (ΔV_{CNP}) as a function of successive modifications for a set of three GFETs.

FIG. 26 shows a) surface mass density after each modification step for VS-PEI/rGO-SPR sensors, b) steady-state θ_{SPR} response as a function of SARS-CoV-2 (circles) and MERS (triangles) spike protein concentration for VS-PEI scaffolds modified with spike protein. Inset: Kinetic SPR response during the elution of 6.53, 13.07 and 65 nM SARS-CoV-2 S1 protein for the same sensor. Association and dissociation best fits are plotted with solid lines. k_{diss}=3.26×10⁻⁴ s⁻¹, kₐₛₛ6.74×10³ (M)⁻¹s⁻¹ and K_{D}=48.4 nM, c) θ_{SPR} response as a function of human ferritin concentration for VS-PEI scaffolds modified with mAb-FTH1 (circles) or BSA (triangles). Inset: Kinetic SPR response during the elution of 1.74, 3.5 and 35 nM human ferritin for the same sensor. k_{diss}=2.60×10⁻⁴ s⁻¹, kₐₛₛ1.02×10⁵ (M)⁻¹s⁻¹ and K_{D}=2.54 nM, and d) SPR response to SARS-CoV-2 S1 protein after each three regenerations of the biointerface.

FIG. 27 shows a plot of the Surface plasmon resonance (SPR) sensogram during the in-situ construction of the PEI/Urease multilayer nanoarchitecture according to Example 3.

FIG. 28 shows a plot of the urea-response (ΔVᵢ as a function of the urea concentration in logarithmic scale) for the urea biosensor prepared according to Example 3, and its respective linear fit (solid line).

FIG. 29 shows a plot of the Surface plasmon resonance (SPR) sensogram during the in-situ construction of the PDADMAC/Urease multilayer nanoarchitecture according to Example 3.

FIG. 30 shows a plot of the potassium-response (ΔV as a function of the potassium concentration in logarithmic scale) for the potassium sensor prepared according to Example 4, and its respective linear fit (solid line).

FIG. 31a) shows the gFET response to 5 nM Ferritin (VDS=50 mV, VGS=−250 mV, HEPES 1 mM, NaCl 10 mM, CaCl2 0.05 mM, pH 7.4 buffer). b) Relative IDS changes as a function of the Ferritin concentration.

FIG. 32 shows, in solid line: response of a ferritin biosensor measured using the GELIA approach and obtained for a sample with human ferritin; in dashed line: response of a ferritin biosensor obtained for a sample in the absence of human ferritin.

FIG. 33a) shows the gFET response to 1 nM SARS-CoV-2 spike protein (VDS=50 mV, VGS=−250 mV, PBS pH 7.4). b) Relative IDS changes as a function of the SARS-CoV-2 spike protein concentration and its best fit (dashed line).

### DETAILED DESCRIPTION

The invention will be described in further detail below, with reference to the accompanying figures and by means of non-limiting examples.

The term “sensor” as used herein relates to a device that can be used to detect or measure a physical property, e.g. to qualitatively and quantitatively determine the amount of a specific compound in a solution of interest. The sensors provided herein comprise transistors, which amplify an electronic signal related to the presence and quantity of the specific compound.

The term “semiconducting two-dimensional nanosheets” as used herein relates to a nanostructured material having semiconducting properties and a thickness in a scale ranging from 0.3 to 100 nm from which a FET may be manufactured. Non-limiting examples of these materials include substances as graphene, reduced graphene oxide (rGO), few-layer graphene, twisted bilayer graphene, conducting polymers, transition metal dichalcogenides, black phosphorous, and hexagonal boron nitride (h-BN). The terms “semiconducting material” and “semiconductor” may be used interchangeably in the present disclosure.

As used herein, the term graphene oxide (GO) relates to a material produced by oxidation of graphite by methods well known by one of ordinary skill in the art. Reduced graphene oxide (rGO) is the form of GO that is processed by chemical, thermal and other methods in order to reduce its oxygen content, as described in further detail below.

A field-effect transistor (FET) is a type of transistor which uses an electric field to control the flow of current. FETs comprise at least three electrodes or terminals: source, gate, and drain. FETs control the flow of current by applying a voltage to the gate electrode, which in turn alters the conductivity between the drain and source electrodes.

Consequently, the terms “field-effect transistor comprising semiconducting two-dimensional nanosheets” and “reduced graphene oxide field-effect transistor (rGO-FET)” as used herein relate respectively to a FET that comprises a semiconducting material channel, the semiconducting material being in the form of two-dimensional nanosheets and to a FET that comprises a reduced graphene oxide channel as described in further detail below.

The term “interfacial nanoarchitecture” refers to arrangements of at least a recognition element, a structural element and a polymeric coating, forming the interface between the sensor and the medium to be sensed and having a nanometric characteristic length, which can be obtained by one of the nanoconstruction techniques described in further detail below. The term “multivalent heterobifuctional nanoscaffold” relates to a specific interfacial nanoarchitecture obtained as described in further detail below.

As used herein, the term “supramolecular binding-point” refers to a non-covalent bond mediated by one or more of the following forces: hydrogen bonding, metal coordination, hydrophobic forces, van der Waals forces, π-π interactions and electrostatic interactions.

The invention provides sensors comprising rGO-FETs that use a very low sample volume, in the range of about 1 μL to about 5000 μL, preferably 1 μL to about 1000 μL. To this end, aside from the transistors, the sensors further comprise a substrate as well as a receptacle for the solution to be analyzed that comprises the target molecule or analyte, e.g. a liquid sample, such as biological sample obtained from a patient.

The substrate may be made of a material suitable for supporting the other sensor components, with non-limiting examples including glass, silicon (Si) and silicon dioxide (SiO₂)

The sample may be generally a liquid sample or a biological sample, such as blood, blood serum, saliva, urine and the like. These biological substances contain certain analytes that might be of interest in the diagnosis and treatment of a physiological or psychological condition in a patient.

The invention further provides a system and a method for the instantaneous measurement of a target analyte concentration in a solution, e.g. a liquid or biological sample. The system can be considered an online front-back-end laboratory (OLFBE-LAB).

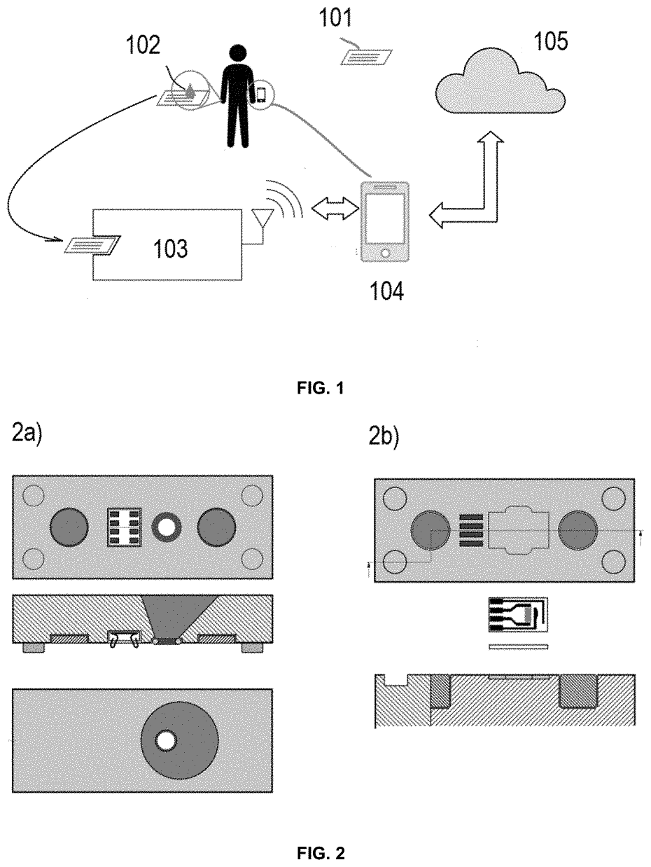

The system provided by the invention can comprise the modules that can be observed in FIG. 1: a sensor or “bioFET” 101 for sensing a liquid sample 102, a measurement and analysis module or “FETmeter” 103, an operator terminal 104 and a hyper-converged infrastructure (HCI) 105.

As previously mentioned, in an embodiment of the present invention, the bioFET sensor comprises at least three contact terminals or electrodes and a receptacle for the solution to be analyzed. The concentration of a target analyte modifies the transfer curve or FET response of the bioFET sensor, from which the concentration can be quantified. The bioFET and its receptacle are configured to achieve measurements using between 1 and 1000 μL of the solution comprising the target analyte.

The FETmeter provides energy to the bioFET sensor by providing a combination of drain and source tensions and gate-source tensions that are controlled by software. By measuring the output current between the drain and the source electrodes, a “transfer curve” or a “FET response” can be obtained, which is dependent on the target analyte concentration. The FETmeter comprises means for transferring data to an operator terminal, e.g. a wireless network to transfer the data to a portable computer, a tablet, a smartphone or the like. The FETmeter may use any type of wireless, or personal area network to directly transfer any data, including but not limited to the raw data and/or the processed data, to an operator terminal which may include a personal computer, a laptop computer, a PDA, smartphone, tablet or the like. The FETmeter may also transfer any data, including but not limited to the raw data or the processed data, to any cloud-based storage service via wireless connection, either using an integrated WiFi chip, an integrated Internet of things (IoT) chip, or a mobile carrier SIM card integrated into the design.

In a still preferred embodiment of the invention, the FETmeter itself may also act as an operator terminal by displaying the data and the controls on a display, such as a LED, LCD, AMOLED display or the like, optionally comprising tactile capabilities to allow the user to interact with the device.

The FETmeter casing is purposefully designed to accommodate a bioFET at a specific location within the casing. In an embodiment of the invention, the bioFET rests at an indentation specifically designed for this purpose, allowing the bioFET to be electrically and chemically separated from any interfering stimuli.

FIG. 2 illustrates the space to deposit the sensor and its location, the space where the testing solution will be deposited to enhance and increase contact with the sensor surface, and how the entire structure is designed to prevent the leaking of the testing solution, e.g. a biological fluid. By covering the bioFET spot, as illustrated in FIG. 2, it is ensured that the drop of sample will only fall within the exposed area of the semiconducting material of the bioFET, thus improving the measurement process.

An algorithm based on signal acquisition, processing, analysis, and curve fitting, yields the value of the target analyte concentration starting from the obtained transfer curves or from other curves of the FET response. The main “landmarks” that can be obtained from the FET response comprise the transconductance, the Dirac point (also called the charge neutrality point, CNP), the minimum current of the transfer curve (or the maximum resistance), the current between the drain and the source electrodes (I_{ds}), among others.

The operator terminal, e.g. a smartphone, tablet, or the like, contains the clinical history of the patient and can eventually transfer relevant data to the patient's physician.

The clinical data can be stored either within the operator terminal or within a HCI such as in a cloud-based storage service and can be transferred by the patient to the patient's physician either in its raw format, as a spreadsheet, or as a PDF file containing either the latest measurements or the entire history of measurements.

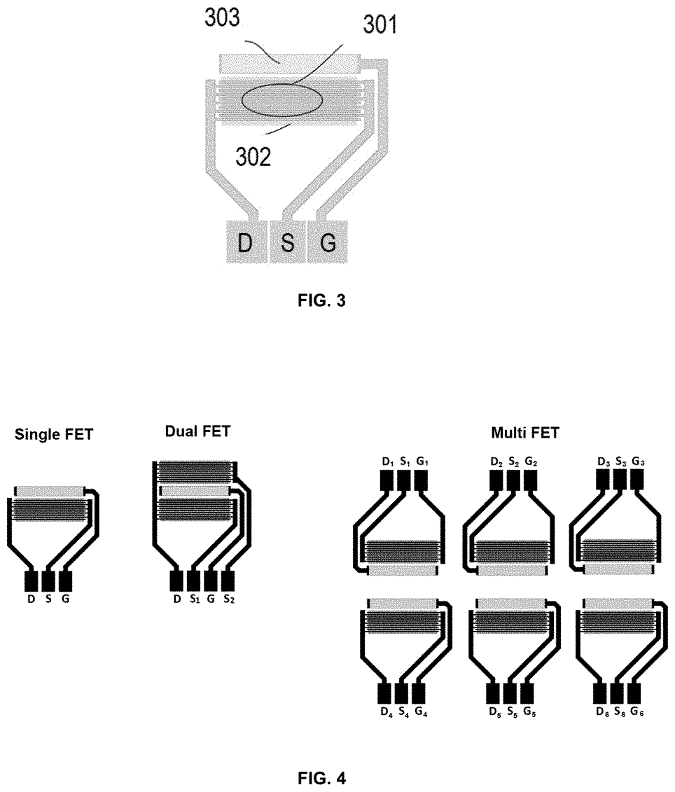

The bioFET sensor provided by the invention comprises a FET, as illustrated in FIG. 3, wherein the current circulating between the two main terminals, i.e. drain (D) and source (S), is a function of target analyte concentration in the solution bathing the two main terminals and the gate terminal (G), as well as the excitation voltage between these three terminals.

With regards to FIG. 3, the FET comprises a plurality of thin conductive tracks corresponding to one of the main terminals, alternated with another plurality of tracks corresponding to the other main terminal, meaning that the terminals or electrodes 203 are interdigitated. A layer of graphene 302 is deposited on the surface of the interdigitated electrodes, as discussed in further detail below. The third terminal, i.e. the gate terminal 303, is achieved by a coating of Ag/AgCl.

The FET is completed by bathing, i.e. being immersed in an electrolytic solution, since the electrolyte acts as an electrical connection between the gate terminal and the graphene.

In an embodiment of the present invention, in order to render the graphene sensitive to the precise detection of a specific target analyte, the graphene is modified by means of a recognition element, e.g. substance complementary to the target analyte. The electric current between the drain and source terminals will be a function of the number of analyte molecules coupled to the complementary substance.

In order to render the bioFET less sensitive to variables exogenous to the analyte determination objective variables, a dual-bioFET can be provided, as seen in FIG. 4. In this configuration, one of the elements of the bioFET is configured for the specific target analyte, while the other element remains in its neutral state, i.e. without begin customized. The exogenous variables, such as temperature, number of dissolved ions, ion mobility, etc. affect both elements in a similar manner, allowing their effects to be cancelled out.

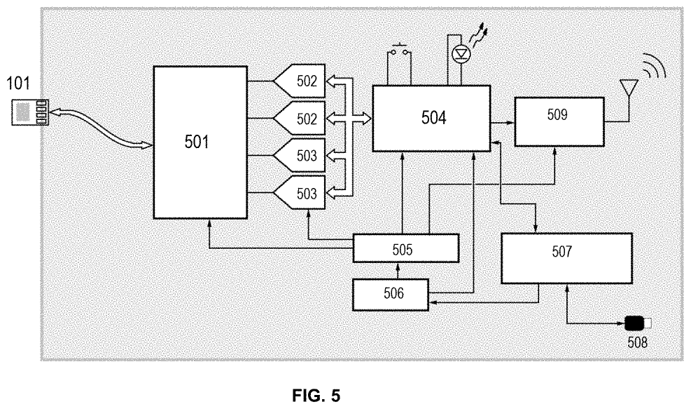

With reference to FIG. 5, the FETmeter is the module that provides excitation to the main terminals of the bioFET, i.e. drain and source by means of a voltage controlled by the microprocessor in accordance with the software. As seen in FIG. 5, the bioFET 101 is excited by the the FETmeter, which comprises an analog circuit 501 and a plurality of analog-to-digital (ADC) 502 and digital-to-analog (DAC) 503 converters, connected to the microprocessor 504. The FETmeter may be provided with regulators 505, a power source such as a battery 506, a USB module 507 for charging with a USB connector 508, as well as a Bluetooth module 509.

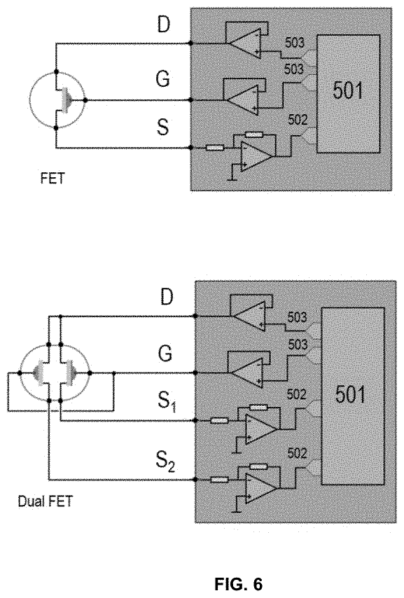

FIG. 6 shows the basic analog circuits for both a single-FET and a dual-FET configuration.

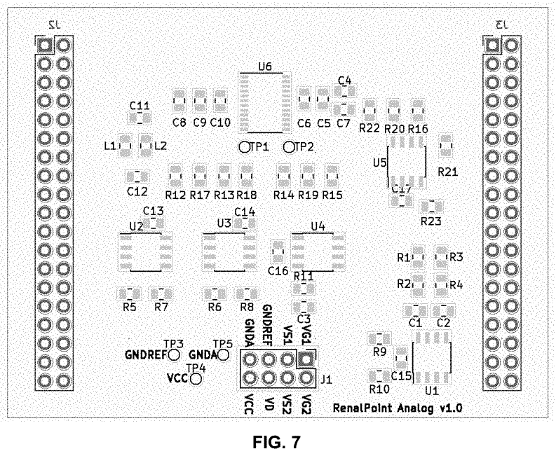

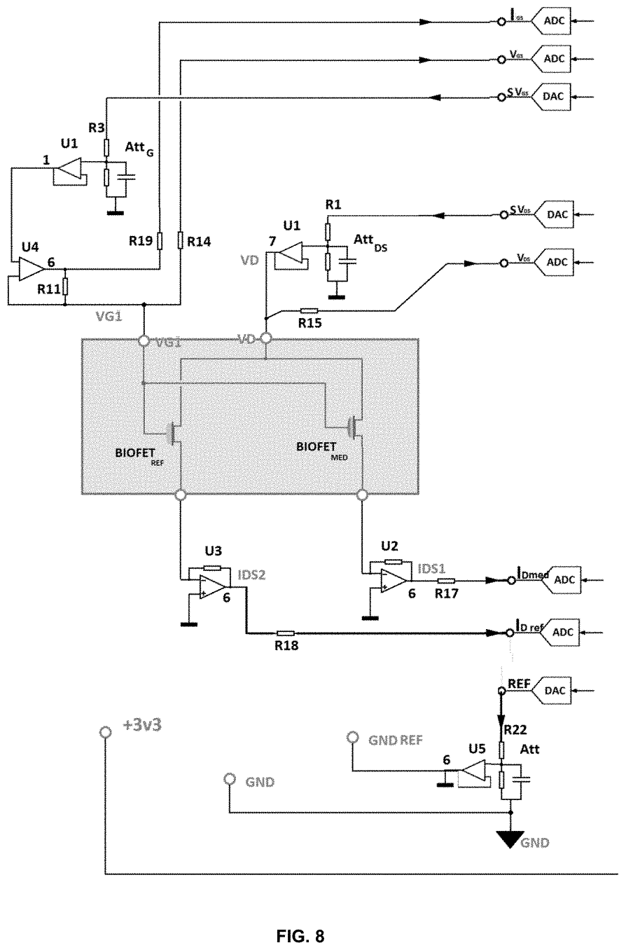

A schematic representation of the analog module of the FETmeter can be seen in FIG. 7. A detailed analog circuit is shown in FIG. 8.

In order to obtain the FET transfer curve or the FET response, used to extract the data to enter in the algorithm that calculates the target analyte concentration, the FETmeter excites the gate terminal with a controlled voltage by the microprocessor, in accordance with the software.

The FET transfer curve is obtained by measuring the current between the source and drain electrodes (i.e., the current flowing through the rGO) while the voltage between the gate and the source electrodes is swept using a potential function and the voltage between the drain and the source electrodes is maintained constant. FET responses can be obtained with the FETmeter by applying potential functions to the sensor. The FETmeter records the generated current in the drain-source circuit and in the source-gate circuit, which by means of an analog-to-digital converter (ADC) enters the microprocessor that uses the calculation algorithm to calculate the target analyte concentration.

In the dual-FET configuration, according to the present invention, a controlled voltage is applied between the drain terminals and the source terminals and the currents generated in the main circuits are measured in each of the elements. These signals are recorded by means of ADCs that enter the microprocessor, which applies the exogenous variable cancellation algorithm, and in turn applies the target analyte concentration calculation algorithm.

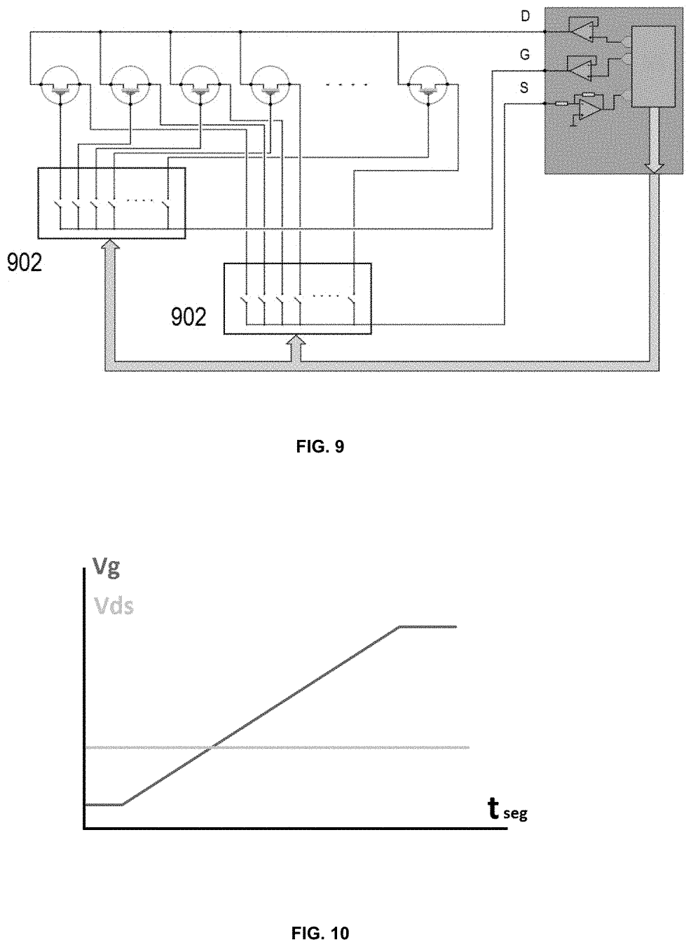

In the multi-FET configuration comprising n FETs (n=1, 2, 3, . . . ), analog multiplexers controlled by the microprocessor may be provided to commutate the gate and source terminals of each transistors, in order to sequentially measure the currents of each FET, from FET₁ to FETₙ. Such an arrangement is illustrated in FIG. 9, where a gate multiplexer 901 and a source multiplexer 902 are shown. Both the source and gate power sources have switches that allow for the current to flow to one FET at a time, sequentially, thus providing the basis for a multi-plex FETmeter.

The sweeping voltages in order to obtain the bioFET transfer curve is a continuous voltage in the range of 0.1 to 1000 mV, preferably 100 mV between the drain and source terminals, and a ramp between the gate and the source terminals, as can be seen in FIG. 10.

As can be seen in FIG. 11, a square wave can be overlapped to the sweeping ramp in order to detect the sign inversion in the curve slope, corresponding to the valley of the curve.

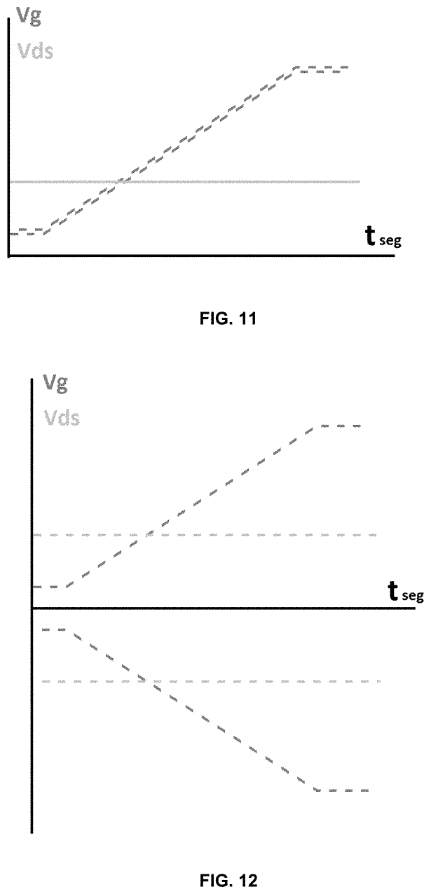

In order to achieve increased symmetry in the measurement process, the polarity of the drain and source voltage and of the gate voltage are reversed as shown in FIG. 12, so as to prevent ion migration from and to the electrodes, and their accumulation in neighboring regions, thus minimizing errors while measuring the data.

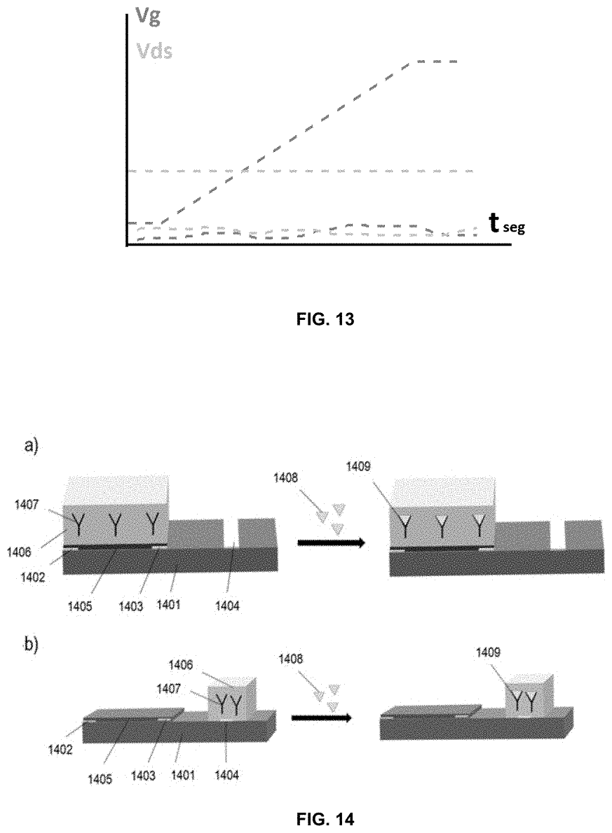

Another available tool is the sequential disconnection of each of the dual-FET elements, in order to cancel out the crossing currents, as illustrated in FIG. 13.

With the disconnection of each terminal, the electric potential of the contact interphases can be measured, which are considered by the algorithm in order to cancel out said electric potentials during calculation of the target analyte concentration.

The invention further provides a method to prepare a sensor comprising rGO-FETs.

As a first step, a graphene oxide solution is homogenized by means of a two-stage centrifugation process. In this step, a graphene solution with a concentration in the range of 1 to 4000 μg/mL, preferably 80 μg/mL in distilled water is brought to a pH above 2 by the addition of an alkali compound. The solution is sonicated for about 10 min and then centrifuged at 100 to 2000 rpm, preferably 600 rpm for about 90 min. Once separated, the supernatant is then centrifuged at 4000 to 14000 rpm, preferably 8000 rpm for about 15 min. The supernatant for the latter centrifugation process is discarded and the precipitate or sediment is brought to the initial solution volume using ultrapure water. The resulting solution is sonicated for about 15 min.

Subsequently, the gate terminal, i.e. an Ag/AgCl electrode is prepared in the same plane as the drain and source terminal, i.e. all three terminals or electrodes are coplanar. Since the FETs are “liquid-gated”, the all-coplanar FET design advantageously allows the miniaturization of the sensor, as well as the use of a reduced sample volume.

The gate electrode may be prepared by electroplating or by inkjet printing using inks comprising Ag/AgCl nanoparticles.

In the electroplating process, an electro-reduction potential of −10 to −4000 mV, preferably −130 mV is applied between the gate terminal and an Ag⁰ wire, while simultaneously an electro-oxidation potential of 0 to 4000 mV, preferably 400 mV is applied between the interdigitated electrodes and the Ag⁰ wire for about 12 minutes in an electrolytic solution comprising Ag₂SO₄.

According to the present invention, the FETs are prepared from reduced graphene oxide and substrates comprising glass, Si or SiO₂ and having coplanar gate, drain and source terminals or electrodes made of a conductive material selected from gold, platinum, graphite, silver and combinations thereof, wherein the drain and the source electrodes are interdigitated, as described above.

Preparation of the FETs comprises incubating the substrates comprising the gate, drain and source electrodes, i.e. the chips, in a solution of (3-aminopropyl)triethoxysilane (APTES) in an organic solvent at a concentration of 0.1% to 10%, preferably 2% during about 1 hour. The APTES-modified chips are then further incubated in the GO solution, prepared as indicated above, for about 1 hour. The obtained chips are washed with deionized water in order to remove GO in excess.

The GO layers thus deposited onto the chip surface are subsequently reduced by exposure to hydrazine vapors at a temperature between 50 and 120° C., preferably 80° C., for about 12 hours in a closed recipient.

The chip is then placed in a stove at a temperature of 50° C. to 500° C., preferably 200° C., for about 2 hours.

Subsequently, a partial oxidation of the Ag⁰ gate electrode to form AgCl is carried out by electroplating in a chloride containing solution, e.g., a NaCl solution at 3 M or a KCl solution at 3 M, or the like, and by applying an oxidation potential of about 150 mV (versus an Ag/AgCl reference) to the Ag⁰ gate electrode, while a reduction voltage of about −100 mV (versus an Ag/AgCl reference) is applied to the interdigitated electrodes for about 60 seconds.

The steps above are carried out for single-FET, dual-FET and multi-FET sensor configurations as described above, prepared from substrates comprising coplanar gate, drain and source electrodes, wherein the drain and source electrodes are interdigitated electrodes.

Each of the electroplating and the partial-oxidation processes can be carried out using the FETmeter device to obtain single-FET, dual-FET and multi-FET sensors with the Ag/AgCl coating.

An interfacial nanoarchitecture is prepared over the rGO-FET, as illustrated for example in FIG. 14. The interfacial nanoarchitecture comprises a recognition element specific to a target biomolecule (e.g. urea, creatinine, acetylcholine, dopamine, protein, virus, among others), structural elements that hold the recognition element immobilized on the rGO-FET surface within a distance of 0 to 100 nm from the rGO surface, and an anti-fouling polymer layer, to avoid the adsorption of non-specific biomolecules. By using this interfacial nanoarchitecture, the recognition element, such as an enzyme, an aptamer, an antibody, a CRISPR/Cas complex, among others, is immobilized by the structural elements, such as a polyelectrolyte, a polymer and a cross-linker molecule, among others, through non-covalent bonds and with nanoscale precision. Furthermore, the structural element is attached to the semiconducting two-dimensional nanosheet by one or more supramolecular binding-points.

As illustrated by Examples 2 and 3 below, advantageous results of immobilizing the recognition element through a structural element which is attached to a semiconducting nanosheet by one or more supramolecular binding-points include: i) supramolecular bonds do not disrupt the band structure or the chemical structure of the semiconducting two-dimensional nanosheet. Thus, the semiconducting properties of the FET sensor are not deteriorated, and the sensor retains its maximum charge carrier mobility, transconductance and sensitivity. ii) Multivalent supramolecular interactions between the structural element and the semiconducting nanosheet ensure a nanoarchitecture with high stability. This feature enables a better reproducibility and the regeneration of the biosensor surface for its reuse.

According to the present invention, the step of providing this interfacial nanoarchitecture comprises the surface modification of the FET with the recognition element, the structural element, and the antifouling polymer layer, by employing nanoconstruction techniques. Layer-by-layer assembly, self-assembly, polymer salt-complex, spin-coating, drop-casting are examples of the nanoconstruction techniques based non-covalent binding that can be used for the preparation of the interfacial nanoarchitecture of the invention.

Unexpectedly, surprisingly improved sensing features can be obtained by a synergistic effect between the interfacial nanoarchitecture and the FET. This effect is illustrated in Example 3 below, which describes a polyelectrolyte/enzyme nanoarchitecture prepared onto the rGO-FET for the sensing of urea, resulting in an improved sensitivity of the biosensor due to the synergy between the functionality of the polyelectrolyte used in the nanoarchitecture and the field-effect of the sensor. This synergistic effect is also illustrated in Examples 4 and 5, which describe a multivalent heterofunctional nanoscaffold to immobilize antibodies onto rGO-FET for the sensing of antigens, resulting in improved sensitivity, stability and with diminished non-specific adsorption.

For interfacial nanoarchitectures onto rGO-FETs prepared using the layer-by-layer nanoconstruction technique, in an embodiment, this step comprises submerging rGO-FETs obtained in the previous steps into a solution of a charged pyrene molecule, preferably 1-pyrenesulfonate, in dimethylformamide (DMF) at a concentration between 0.1 and 10 mM, preferably 3 mM. A polyelectrolyte is then assembled by submerging the rGO-FET into a solution of the polyelectrolyte, preferably selected from polyethyleneimine (PEI), poly(allylamine hydrochloride) (PAH) or poly(diallyldimethylammonium chloride) (PDADMAC) at a concentration between 0.05 and 50 mg/mL, preferably 2 mg/mL for about 10 minutes, with subsequent washing using distilled water.

The rGO-FET modified with the polyelectrolyte is then submerged into a solution comprising the recognition element for about 30 min and washed with distilled water. In the case of an enzyme solution, the concentration may be between 0.05 and 50 mg/mL, preferably 1 mg/mL. This step promotes the adsorption of the recognition element onto the rGO surface.

The recognition element may be chosen according to its complementarity with the target analyte to be detected or measured. For example, the enzyme urease may be used as the recognition element for the analyte urea, an antibody can be used as the recognition element for a corresponding antigen, etc. In different embodiments of the present invention, other recognition elements suitable for the preparation of the interfacial nanoarchitecture on the rGO-FET comprise aptamers, clustered regularly interspaced short palindromic repeats (CRISPR) with a CRISPR associated protein (Cas) and ionophores.

These last steps using the polyelectrolyte and recognition elements can be repeated in alternation to increase the surface concentration of the recognition element. Preferably, the finished assembly comprises a polyelectrolyte outermost layer.

As an alternative embodiment, the interfacial nanoarchitecture is obtained by modifying the graphene channel or the gate electrode of the rGO-FET with a coating comprising an ion-selective membrane. The ion selective membrane comprises a combination of an ion-selective molecule (ionophore) as the recognition element, a hydrophobic electrolyte, a plasticizer and a high molecular weight hydrophobic polymer as the structural element. This modification can provide a sensor for detection of ions such as K⁺, Cl⁻, Ca²⁺, PO₄³⁻ and the like. For the preparation of a potassium-selective membrane, an ion-selective cocktail comprising o-nitrophenyl octyl ether (o-NPOE) (65.88%), polyvinyl chloride (PVC) (33%), potassium ionophore I, also named valinomycin, (1%), and potassium tetrakis (p-chlorophenyl) borate (KTPCIB) (0.22%) in 2.5 mL of Tetrahydrofuran (THF) can be employed. The ion-selective cocktail is used for the modification of rGO-FET by spin-coating, drop-casting, or dip-coating.

In the interfacial nanoarchitecture, the distance of the recognition element to the surface of the rGO can be modified using nanoconstruction techniques such as the layer-by-layer assembly of polyelectrolytes and recognition elements. By employing these techniques, it is possible to locate the recognition elements onto the rGO surface with nanometric precision.

The recognition element can be at a distance of up to 100 nm from the rGO surface. Advantageously, the rGO-FET sensors with recognition elements comprised in an interfacial nanoarchitecture as provided by the present invention have an amplified sensibility compared to those rGO-FET sensors wherein the recognition element is directly linked to the rGO or graphene surface, i.e. without an interfacial nanoarchitecture. Without being bound by any theory, this sensitivity amplification occurs since rGO-FETs sensors transduce any field-effect change onto the rGO interface within a distance in the range of 0 to 100 nm. Therefore, when a target analyte is recognized using the recognition elements comprised in the nanoarchitecture, prepared as described in the present invention, the response and sensitivity are maximized. Moreover, the structural element of the nanoarchitecture may be functional polymers that change its charge when the recognition event occurs, triggering a second effect of signal amplification. On the other hand, when the recognition element is directly linked to the rGO surface, the potential response is not exploited.

As a finishing step, in an embodiment of the invention, the obtained nanoarchitecture comprising the recognition element and the structural element is post-modified by deposition of an antifouling polymer coating. To this end, a solution comprising an antifouling polymer, such as a polyethylene-glycol (PEG), a polyethylene-glycol derivatized polymer, a zwitterionic polymer, a fluoropolymer, e.g., a tetrafluoroethylene-perfluoro-3,6-dioxa-4-methyl-7-octenesulfonic acid copolymer, at a concentration of about 0.5% by weight is dropped over the nanoarchitecture which contains the recognition element and is on the rGO-FET, and subsequently dried at a temperature of about 4° C. An anti-fouling film that covers the nanoarchitecture is thus obtained, thereby enhancing the stability of the deposited layers, as well as preventing the non-specific adsorption of molecules other than the target analyte, that may result in interfering electronic signals.

By constructing the interfacial nanoarchitecture onto the rGO-FET as provided by the present invention, a broad variety of target analytes can be determined. A few non-limiting examples of target analytes that can be quantified are:
Urea, using urease enzyme as the recognition element.
Potassium (ion), using potassium ionophore I, also named valinomycin, as the recognition element.
Creatinine, using creatinine deiminase enzyme as the recognition element.
Ferritin, using anti-ferritin antibodies or aptamers as the recognition element.
Interleukin-6 (IL6), using anti-I L6 antibodies or aptamers as the recognition element.
SARS-CoV-2 spike-protein, using antibodies or aptamers against SARS-CoV-2 spike protein as the recognition element.
SARS-CoV-2 nucleocapsid (N) protein, using antibodies or aptamers against SARS-CoV-2 nucleocapsid (N) protein as the recognition element.
DNA or RNA specific sequences, using CRISPR/Cas systems specific to that DNA or RNA sequence as the recognition element.
Acetylcholine, using acetylcholinesterase enzyme as the recognition element.
Dopamine, using catalytic nanoparticles as the recognition element.
Hormones related to female fertility such as luteinizing, estradiol, follicle-stimulating hormone, anti-Mullerian hormone, beta-human chorionic gonadotropin, prolactin, using aptamers or antibodies as the recognition element.

The detection process using a FET sensor modified with a nanoachitecture comprising the recognition element is illustrated in FIG. 14. In FIG. 14a), the sensor comprises a substrate 1401, a source electrode 1402, a drain electrode 1403 and a gate electrode 1404. The semiconductor channel 1405 is made of a semiconducting material, such as reduced graphene oxide, and the nanoarchitecture 1406 is prepared over the semiconducting material. The recognition element 1407 is adapted for detection of a target analyte 1408 by an interaction 1409 between the recognition element 1407 and the target analyte 1408. FIG. 14b) illustrates an alternative embodiment for the detection process using an rGO-FET sensor modified with a nanoarchitecture comprising the nanoarchitecture 1406 prepared over the gate electrode.

In specific embodiments, the sensor provided by the invention may be obtained by the synthesis of vinylsulfonated-polyamines (VS-PA) scaffolds linked, from one side, to graphene through multivalent π-π interactions with pyrene groups, and, from the other side, to lectins or antibodies (as recognition elements) and PEG (as the antifouling element) through covalent bonds.

These heterobifunctional scaffolds are constructed by three simple surface modifications: i) pyrenebuthanoic acid succinimidyl ester (PBSE) adsorbs onto graphene; ii) polyamines in aqueous solutions react quickly with PBSE, forming a multipoint attached film through pyrene groups; iii) remaining primary amine groups are modified with divinylsulfone (a well-known crosslinker of —SH, —NH₂ and OH— groups via Michael type addition) to obtain VS-PA grafted onto graphene.

Non-limiting examples of the polyamines that can be used for the heterobifunctional scaffolds are homopolymers or copolymers of polyallylamine, polyethyleneimine, polybutenylamine, polylysine and polyarginine.As detailed in the examples set forth below, the heterobifunctional interface construction was monitored step-by-step by spectroscopic ellipsometry and contact angle. Vinylsulfonation of polyamines was proved by Raman spectroscopy and, then, its reactivity to hydrophilic molecules containing —SH, —NH₂ or OH— groups was demonstrated by contact angle. Furthermore, it is shown by FETs measurements that the VS-PA preparation does not affect the semiconducting propiertes of graphene. Attachment of recognition elements to VS-PA was optimized firstly for concanavalin A (ConA), a model lectin with high affinity to glycans. For the present disclosure, the stability of the interfacial nanoarchitecture in surfactant content media, its antifouling properties and the recognition of a glycoprotein was studied by ellipsometry and surface Plasmon resonance spectroscopy (SPR). Finally, scaffolds containing monoclonal antibodies (mAbs) against SARS-CoV-2 spike protein (mAb-SARS-CoV-2 spike) and human ferritin (mAb-FTH1) were studied by SPR for the specific recognition of their target molecules. K_{D} equilibrium constants and a simple method to reuse the interface are also provided herein.

The method disclosed herein are also used to obtain sensors based on FETs obtained from other semiconducting materials in two-dimensional nanosheets, such as graphene, few-layer graphene, twisted bilayer graphene, conducting polymers, transition metal dichalcogenides, black phosphorous, and hexagonal boron nitride. Due to the similarity of dimensional aspect ratio, semiconducting properties, and molecular conformation properties between these semiconducting materials, the interfacial nanoarchitecture comprising a structural element attached to the semiconducting nanosheets by one or more supramolecular binding-points can be used with any of the previously mentioned semiconducting materials in two-dimensional nanosheets in order to obtain sensors based on FETs. Moreover, the methods described herein for the construction of FET-based sensors with interfacial nanoarchitectures can be applied with to this group of materials, which will be readily apparent to the skilled person. It is important to note that the disadvantages of the devices of the prior art described herein as compared to rGO-FET sensors are also present in the devices of the prior art comprising FET sensors of other semiconducting materials in two-dimensional nanosheets. In concordance, the improvements obtained by the use of the methods described herein for rGO-FET sensors can be also observed for other for other semiconducting two-dimensional nanosheets FET sensors. Thus, the invention provided by the present disclosure solves not only needs for rGO-FET sensors, but also for other semiconducting two-dimensional nanosheets FET sensors.

### EXAMPLES

### Example 1—Preparation of a rGO-FET Sensor

A rGO-FET sensor provided by the invention, as described above, was prepared using the following compounds and equipment.

The FETs were prepared from graphene oxide and glass substrates having coplanar gate, drain and source terminals or electrodes made of gold.

As a first step, a graphene oxide solution was homogenized by means of a two-stage centrifugation process. In this step, a graphene solution with a concentration of 80 μg/mL in distilled water was brought to a pH above 8 by the addition of NaOH. The solution was sonicated for about 10 min and then centrifuged at 600 rpm for 90 min. Once separated, the supernatant was then centrifuged at 8000 rpm for 15 min. The supernatant for the latter centrifugation process was discarded and the precipitate or sediment was brought to the initial solution volume using ultrapure water. The resulting solution was sonicated for 15 min.

Subsequently, the gate terminal, i.e. an Ag/AgCl electrode was prepared in the same plane as the drain and source terminal, by the electroplating process. An electro-reduction potential of −130 mV was applied between the gate terminal and an Ag⁰ wire, while simultaneously an electro-oxidation potential of 400 mV was applied between the interdigitated electrodes and the Ag⁰ wire for 12 minutes in an electrolytic solution comprising Ag₂SO₄.

Preparation of the FETs comprised incubating the substrates comprising the gate, drain and source electrodes, i.e. the chips, in a solution of (3-aminopropyl)triethoxysilane (APTES) in absolute ethanol at a concentration of 2% during 1 hour. The APTES-modified chips were then further incubated in the GO solution prepared as indicated above for 1 hour. The obtained chips were washed with deionized water in order to remove GO in excess.

The GO layers thus deposited onto the chip surface were subsequently reduced by exposure to hydrazine vapors at a temperature of 80° C., for 12 hours in a closed recipient. The chip was then placed in a stove at a temperature of 200° C., for 2 hours.

Subsequently, a partial oxidation of the Ag⁰ gate electrode to form AgCl was carried out by electroplating in a 3 M NaCl solution and by applying an oxidation potential of 150 mV (versus an Ag/AgCl reference) to the Ag⁰ gate electrode, while a reduction voltage of −100 mV (versus an Ag/AgCl reference) was applied to the interdigitated electrodes for 60 seconds.

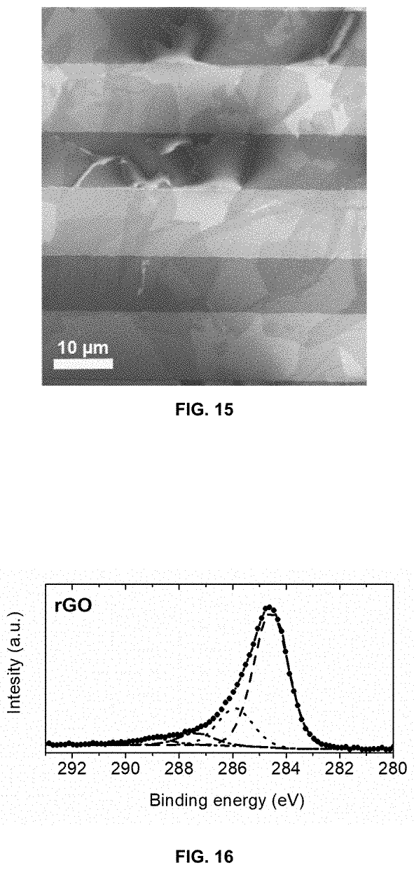

The scanning electron microscopy (SEM) characterization of the rGO-FET is shown in FIG. 15.

The X-ray photoelectron spectroscopy spectrum of the chemically reduced rGO is shown in FIG. 16.

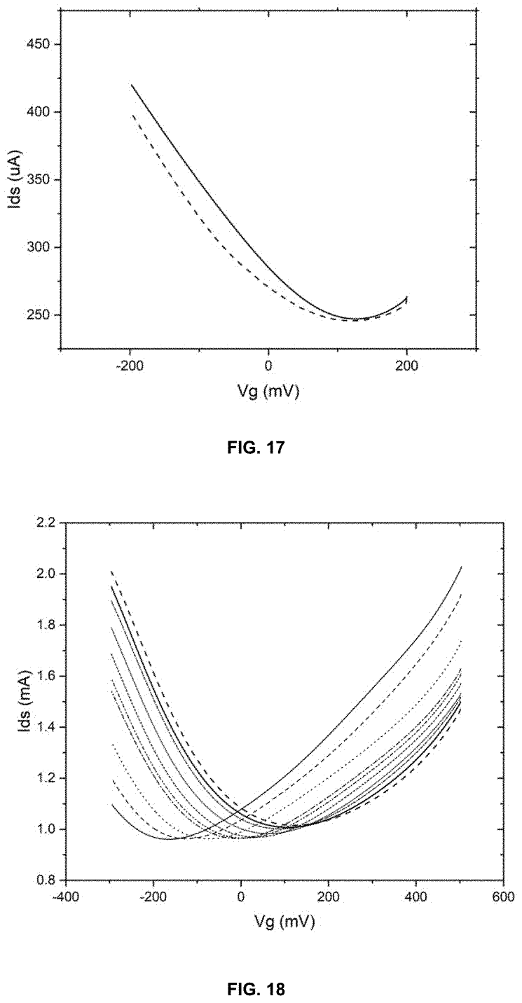

The drain-source current (I_{ds}) as a function of the gate-source potential (V_{g}) for this rGO-FET was measured with the FETmeter in buffer solution (1 mM KH₂PO₄, 4 mM KCl, 27 mM Na₂CO₃ and 88 mM NaCl and pH=7.4) using as gate electrode both an external Ag/AgCl wire (dashed line, FIG. 17) and an inner electrodeposited and subsequently oxidized Ag/AgCl electrode (solid line, FIG. 17). For these measurements, the voltage between drain and source (ΔV_{ds}) was 100 mV and a 10 mV/s scan rate was used.

As shown in FIG. 18, the transfer curves for a rGO-FET were also measured in solutions of different pH values: 2 (solid line) 3 (dashed line) 4 (dotted line) 5 (dash-dot line) 6 (dash-dot-dotted line) 7 (short-dashed line) 8 (short-dotted line) 9 (short-dash-dotted line) 10 (thick solid line) 11 (thick dashed line). The measurements were made in 1 mM KH₂PO₄, 3 mM KCl and 137 mM NaCl solution. For these measurements, the voltage between drain and source (ΔV_{ds}) was 100 mV and a 10 mV/s scan rate was used.

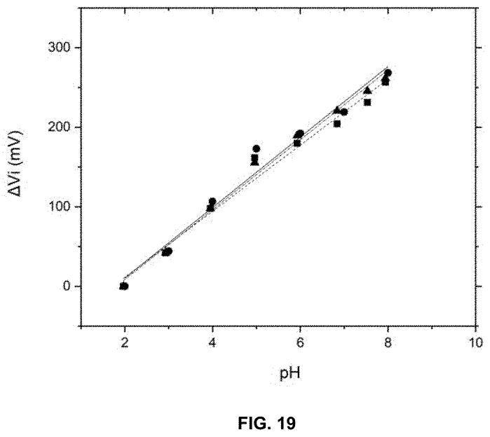

Moreover, FIG. 19 shows a plot of the Dirac point voltage (ΔVᵢ), also called the charge neutrality point (CNP), obtained from the transfer curves in FIG. 18 as a function of pH value for three rGO-FETs (devices 1, 2 and 3) with its respective linear fit. Each rGO-FET was illustrated as follows: 1, circular point and solid line; 2, square point and dashed line; 3, triangular point and dotted line. The measurements were made in 1 mM KH₂PO₄, 3 mM KCl and 137 mM NaCl solution.

### Example 2—Preparation of Sensors Based on Multivalent Heterobifuctional Nanoscaffolds

Supramolecular scaffold of vinylsulfonated-polyamines (VS-PA) onto graphene covered surfaces were prepared by sequential surface modification steps: i) graphene modified substrates/sensors (rGO) were incubated in a dimethylformamide (DMF) solution containing 5 mM 1-pyrenebuthanoic acid succinimidyl ester (PBSE) for 2 h. Then, washed with DMF and dried; ii) PBSE-modified graphene substrates/sensors (hereafter PBSE/rGO) were then incubated in 2 mg/mL Polyallilamine (PAH) or polyethilenimine (PEI) at pH=10 for 1 h, washed with deionized water and dried; iii) the VS-PA scaffolds (hereafter VS-PA/PBSE/rGO), were obtained by incubating the polyamine-modified PBSE/rGO substrates/sensors in 5% divinylsulfone (DVS) solution in carbonate buffer (0.5 M Na₂CO₃, pH=11) for 1 h, washed with deionized water and dried.

Binding of small motifs to VS-PA/PBSE/rGO substrates/sensors was carried out as follows: a) mannose binding (through —OH groups) was done by incubating the substrates/sensors in a 10% wt mannose in carbonate buffer solution (0.5 M Na₂CO₃, pH=11) for 18 h. b) Cysteine binding (through —SH groups) was done by incubation of the substrates/sensors in 10 mM cysteine in PBS pH=7.4 for 12 hs. c) Lysine binding (through —NH₂ groups) was done by incubation of the substrates/sensors in 10 mM L-Lysine in borate buffered saline solution (BBS, 10 mM sodium borate, 140 mM NaCl pH=9.0) for 12 h.

Binding of proteins and antibodies to VS-PA/PBSE/rGO was carried out as follows: i) the substrates/sensors were incubated in 100 μg/mL protein or antibody solution in BBS pH=9.0 buffer for 5 h (at this pH, the Cys and Lys groups of the protein will react covalently with VS-PA), and then washed with BBS. ii) The antifouling of the substrates/sensors was done by incubating them in 0.2 mM PEG-NH₂ (10 kDa) solution in BBS pH=9.0 for 2 h and washing with BBS. iii) Substrates/sensors were finally incubated in 100 mM ethanolamine (ETA) solution in BBS pH=9.0 for 30 minutes, to block vinyl sulfone remaining groups, wash with BBS and store in buffer.

Spectroscopic Ellipsometry (SE) was employed to study the scaffold construction in a step-by-step manner, since it is a highly sensitive, non-destructive, and reproducible technique. After PBSE modification, polyamines were attached to the surface by reaction of their ammino groups with the succinimide group from PBSE. Particularly, low- and high-molecular-weight (Mw) poly(allylamine) (PAH, 17.5 and 140 kDa) and poly(ethylenimine) (PEI, 25 and 750 kDa) were used. For the construction of the optical model, a Cauchy layer was introduced on top of the rGO layer, and its thickness was adjusted until optimal fit.

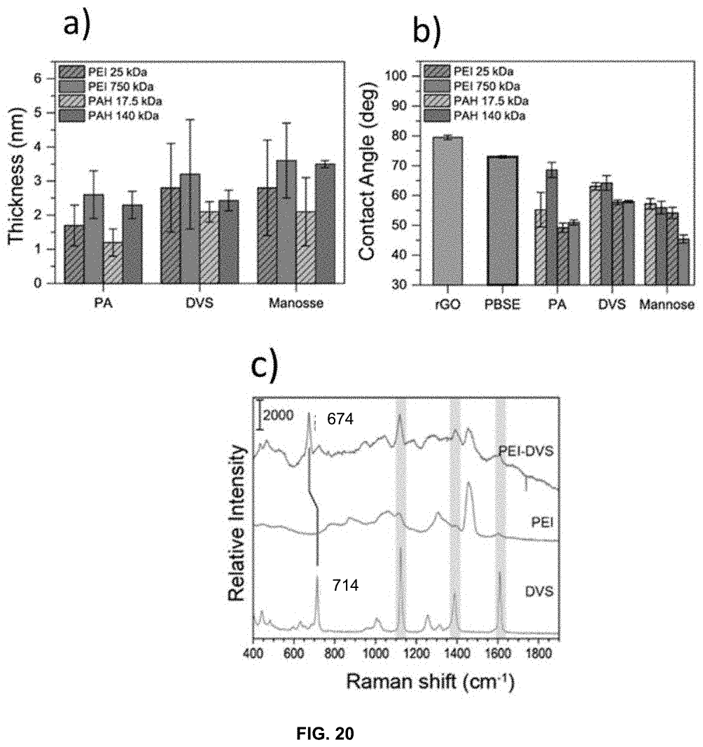

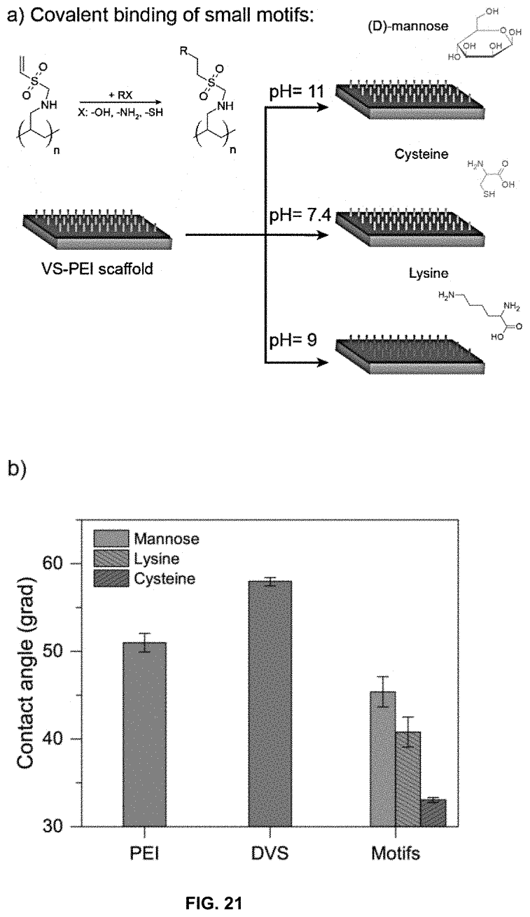

As it can be seen through the thickness evolution of the PA layer in FIG. 20a), both PAs are being successfully cast on PBSE/rGO surface, although the use of PEI allows for a thicker PA layer on the graphene surface. Mw impacts the thickness of the PA layer; higher Mw means thicker PA layers deposited. Given the optical model considered, where a uniform and homogeneous PA layer is assumed to be formed and further represented as a Cauchy layer, information about the coverage is needed; as a complementary characterization of the surface modifications then, contact angle (CA) measurements were performed and the results are depicted in FIG. 20b).

Firstly, CA measurements reveal PBSE being anchored to rGO as a decrease in the contact angle by 7.4% (from 78.8°±0.7° to 73.0°±0.5°). Furthermore, PA inclusion is also manifested as a decrease in the CA, but also suggesting that PEI coverage is more efficient than when using PAH; while PAH decreases the CA just by ˜5%, indicating a poor coverage of the PBSE/rGO surface, PEI anchoring seems to be more homogeneous, with a marked decrease of the CA by almost 30%.

PA films were then exposed to divinyl sulfone (DVS), allowing their —NHₓ groups to react with the vinylic groups from DVS. The thickness of this PA-VS layer was estimated through SE, by adjusting the previous thickness of the Cauchy layer. As it can be seen in FIG. 20a) none of the PA seems to be desorbing from PBSE/rGO surface, rather the opposite; while reaction with DVS is not expected to significantly increase the thickness (physically), the optical response of the platform suggests an increase of the electronic density and, since the refractive index of the Cauchy layer is not being allowed to vary, it impacts as a thickness increase (although this effect can be also accompanied by swelling, due to the polarity changes once anchored the DVS together with some structural rearrangements of the polymeric chains). These effects are more notorious on PEI films than PAH films; this also evidences the coverage differences between both platforms. In general, CA increased considerably after DVS reaction, except for PAH 140 kDa, as shown in FIG. 20b).

Mannosylation was used for proving the degree of modification of the vinyl sulfonated-polyamines scaffolds. As displayed in FIG. 20a), it seems to be no desorption of the previously assembled platform, given that thickness remains between similar values (although there is a net increase of thickness for the 140 kDa PAH film). In terms of CA, however, it is evident that the modification with PEI 750 kDa is the system that yields the greatest surface hydrophilicity after the incubation in mannose (45.4°±1.7°), suggesting a higher degree of functionalization.

Raman spectra were collected for DVS and PEI solutions, as well for VS-PEI sample (solid), with an excitation wavelength of 785 nm and they are shown in FIG. 20d), in the region from 400-1900 cm⁻¹. At first glance, typical peaks for PEI and DVS are observed, and both sets of peaks are present in the VS-PEI sample, suggesting the successful reaction between both. Furthermore, there was a significant shift on the DVS peak at 714 cm⁻¹, assigned to the symmetric CS stretching, to 674 cm⁻¹. This shift towards lowers values strongly supports that the reaction between vinylic moieties from DVS and amino and/or imine groups from PEI is taking place.

### Covalent Binding of Small Motifs to VS-PA Scaffolds

These reactions were employed for by covalently docking different motifs, such as mannose (through —OH groups), cysteine (through —SH groups) and lysine (through —NH₂ groups) to VS-PEI scaffolds. To this end, VS-PEI scaffolds were treated in buffer solutions adjusted at different pH values, pH=11 for mannose, pH=7.4 for cysteine and pH=9 for lysine. The incubation of the VS-PEI modified substrates in mannose, lysine or cysteine solutions leads to a marked decrease in the contact angle (45±2° for mannose, 40±2° for cysteine and 33.0±0.3° for lysine) as shown in FIG. 21. In all cases, a noticeable increase of the hydrophilicity of the surface is evidenced, owed to the high hydrophilic character of the amino acids or the carbohydrate, verifying the chemical modification of the surface and displaying the versatility of the formed architecture. No significant difference in thickness was found after each modification step.

### In-Situ PEGylation: Stability of PEG Interfaces onto Graphene

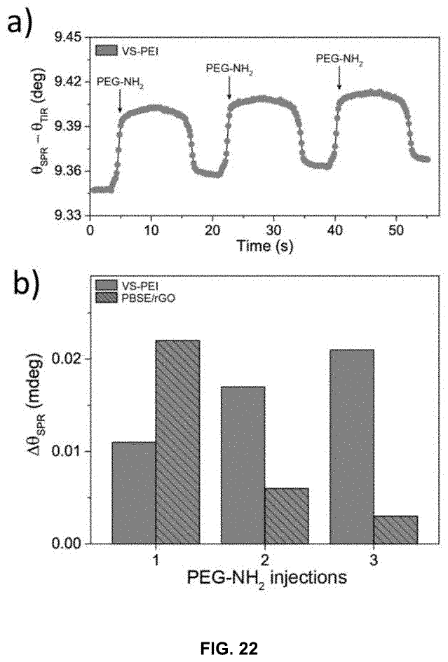

The modification of VS-PEI scaffolds with PEG was studied by in-situ surface plasmon resonance (SPR) spectroscopy. With a flow of 20 μL/min, three consecutive injections of 0.2 mM PEG-NH₂ solution for 12 minutes followed by buffer for 3 minutes were performed. As it can be seen in FIG. 22a), θ_{SPR} increase sequentially with the number of PEG-NH₂ injections, reaching a thickness value of approximately 2 nm after three injections. These results were compared with the PEGylation obtained for PBSE/rGO sensors (see patterns bars of FIG. 22b) since it is the monopyrene most used for the attachment of PEG (see Z. Hao, Y. Pan, C. Huang, Z. Wang, Q. Lin, X. Zhao and S. Liu, ACS Sensors, DOI:10.1021/acssensors.0c00752). A large increase of θ_{SPR} was obtained for PBSE/rGO after the first PEG-NH₂ injection. Nevertheless, an important and non-recoverable PEG mass loss occurred during the washing step and the following two PEG-NH₂ injections. Thus, it is evidenced that the PEGylation of VS-PA modified graphene is much more stable, resulting in higher surface coverage, than coverage observed for not as-strongly adsorbed monopyrenes such as PBSE.

### Covalent Binding of Proteins to VS-PA Scaffolds, and Post-PEGylation for Protein Antifouling

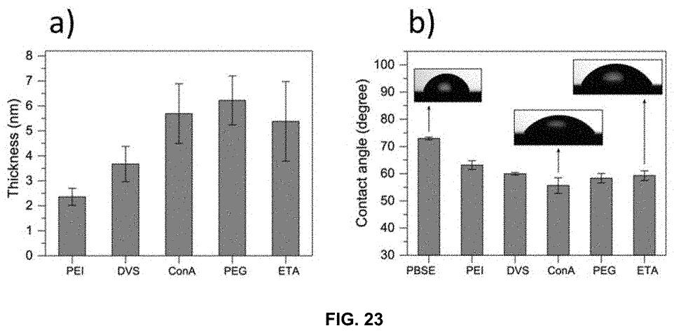

As a model platform, Concanavalin A (Con A, a well-known lectin protein with high lysine content and without cysteine residues) was employed, and PEGylation (PEG-NH₂) was performed afterwards thus providing antifouling capability to the architecture, as will be described in further detail below. Finally, for neutralizing the remaining vinylic groups, substrates were exposed to ethanolamine (ETA) solution. The covalent modification of VS-PA scaffolds with ConA, PEG-NH₂, and ETA, was evaluated by SE and CA measurements. As it can be seen at FIG. 23a)-b), thickness increase of approximately 2 nm and a CA decrease of approximately 5° were observed after the ConA binding. Then, a thickness increase of approximately 0.5 nm was observed after the PEGylation step of VS-PA/ConA substrates. Finally, after blocking the VS- remnant groups with ETA a film thickness decrease of 0.8 nm was observed. Although bar errors seem to include the previously stated changes, the evolution of the CA is clear and confirms the successful integration of each component into the supramolecular scaffold.

To avoid point-to-point variability for masking any effect during the covalent modification of VS-PA scaffolds with ConA, followed by PEG-NH₂ and ethanolamine (ETA) modifications, was monitored by in-situ SPR. From the SPR study, it was observed more than 95% of the protein attached to VS-PA scaffolds during the first 40 minutes. Nevertheless, since the covalent reaction to lysine groups is relatively slow, the incubation of VS-PA scaffolds in the protein solution was maintained during 5 h. PEGylation was performed elapsed that time, showing no desorption but a slight increase of the θ_{SPR}, confirming SE results above discussed: that both ConA anchorage to VS-PEI and later PEGylation steps are taking place. In the monopyrene PBSE approach of the prior art, a decrease of θ_{SPR} is observed during the PEGylation and ETA steps, suggesting some protein desorption. Therefore, ConA bound to VS-PA scaffolds was more stable than those to PBSE.

### Stability of the Architecture, Antifouling Capabilities, and Specific Recognition

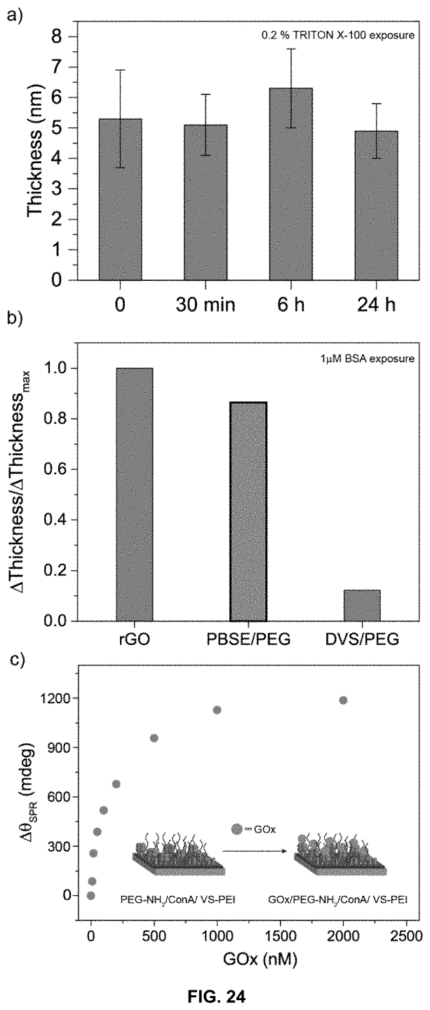

For testing the stability of the architecture, the PEGylated ConA/VS-PEI scaffolds were incubated in a solution of the non-ionic surfactant Triton X-100 0.2% and monitoring the changes in the thickness of the film by SE measurements during 24 h, analyzing the global thickness at different time intervals. For each measurement, the substrates were rinsed with the appropriated buffer and dried. As shown in FIG. 24a), no significant thickness changes are observed after the surfactant treatment (differences are within the deviation of the measurements) suggesting that no desorption of the film components occurs and demonstrating the good stability of the whole architecture.

To analyze the antifouling performance of the PEGylated structures, a reference point was stablished by exposing rGO surfaces to 1 μM bovine serum albumin (BSA) solution in BBS pH=9 for 30 min and rinsed with BBS and deionized water, and dried. The non-specific interaction of BSA with rGO, was manifested in SE measurements as the apparition of a 1.88 nm Cauchy layer. PEGylated PBSE/rGO substrates were first exposed to ETA for blocking the remaining reactive groups, and then exposed to BSA solution as previously stated. The thickness difference of the Cauchy layer after BSA exposure (1.6 nm) was normalized towards the value found for rGO, as shown in FIG. 24b). Finally, PEGylated VS-PEI substrates were also initially exposed to ETA and then to BSA solution, but in this case an increase of 0.23 nm was found, which represents just 12% of the thickness increase found for rGO substrates, also depicted in FIG. 24b). Clearly, PEGylated VS-PEI nanoscafolds leads to superior antifouling properties of the surface.

Having shown the structural stability and antifouling capability of the PEGylated VS-PEI scaffold, it is necessary to explore whether the recognition capacity of the docked biomacromolecules is retained or not. To this end, the biological affinity between ConA (a carbohydrate-binding protein) and glucose oxidase (GOx) (a carbohydrate-residues high content protein) was evaluated in-situ by SPR. GOx solutions of increasing concentrations were injected at 20 μL/min and monitored by graphene SPR sensors modified with ConA by the VS-PA approach. The response at the steady states (i.e. at the equilibrium) of the surface plasmon resonance angle shifts (Δθ_{SPR}) were obtained as a function of the protein concentration (see J. Katrlik, R. S̆krabana, D. Mislovic̆ová, P. Gemeiner, Binding of d-mannose-containing glycoproteins to d-mannose-specific lectins studied by surface plasmon resonance, Colloids Surfaces A Physicochem. Eng. Asp. 382 (2011) 198-202. https://doi.org/10.1016/j.colsurfa.2011.01.020), which is shown in FIG. 24c). By fitting the equilibrium states with equation S1, a K_{D} value of 134±18 nM was estimated, demonstrating that docked ConA retains its recognition capacity after PEGylation (see D. Mislovic̆ová, J. Katrlik, E. Paulovic̆ová, P. Gemeiner, J. Tkac, Comparison of three distinct ELLA protocols for determination of apparent affinity constants between Con A and glycoproteins, Colloids Surfaces B Biointerfaces. 94 (2012) 163-169. https://doi.org/10.1016/j.colsurfb.2012.01.036).

### Semiconducting Properties

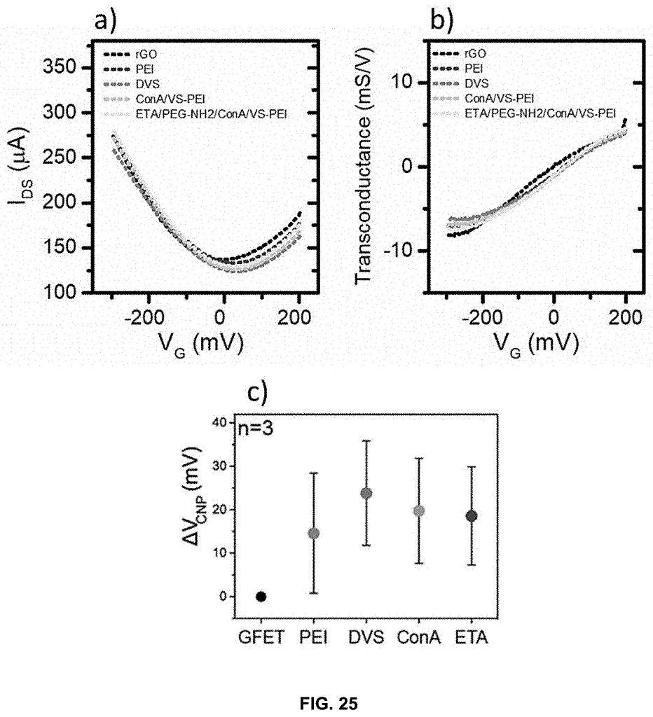

To demonstrate that the construction of supramolecular VS-PA scaffolds does not disrupt the semiconducting properties of graphene, GFETs characteristic transfer curves before and after each modification step were carried out. In FIG. 25a), the transfer characteristic curves measured in buffer HEPES pH=7.4 are shown. FIGS. 25b and 25c), summarize the behavior of relevant parameters for a set of three GFETs: changes in the charge neutrality point (ΔV_{CNP}) and transconductance ([dI_{DS}/dV_{G}]/V_{DS}), respectively. Surprisingly, the transconductance was little affected, evidencing that the VS-PA scaffolds preparation did not disrupt the graphene semiconducting properties neither its conjugated bonds. Moreover, only some minor ΔV_{CNP} variations were displayed after each modification step.

### Covalent Binding of Antibodies to VS-PA Scaffolds for Antigen Recognition

The VS-PEI platform was also assessed for antibody-antigen interfacial recognition onto graphene. To this end, monoclonal antibodies (mAbs) specific against SARS-CoV-2 spike protein (mAb-SARS-CoV-2 spike) and human ferritin (mAb-FTH1) were anchored to VS-PEI.

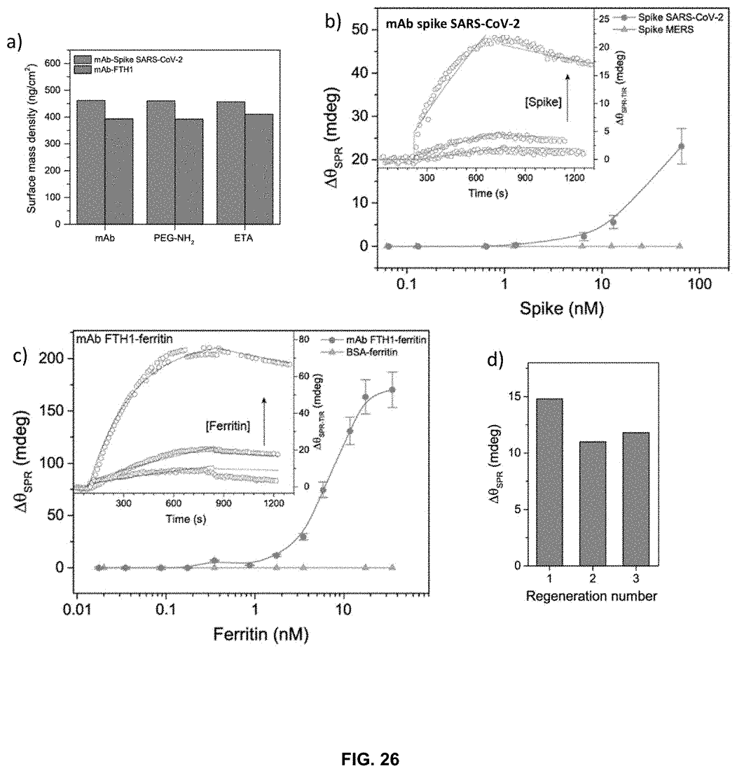

The covalent modification of VS-PEI scaffolds with mAb-SARS-CoV-2 spike protein or mAb-FTH1, followed by PEG-NH₂ and ETA modifications, was monitored by SPR. Surface mass densities of 436±30 ng/cm² were estimated for both mAbs, as illustrated in FIG. 26a). Similar coverage was obtained with the PBSE approach. Nevertheless, a decrease of θ_{SPR} is observed during the PEGylation and ETA steps for the PBSE approach. On the other hand, mAbs bound to VS-PEI scaffolds were found to be more stable.

FIG. 26b) shows Δθ_{SPR} as a function of SARS-CoV-2 S1 or MERS (control) spike protein concentration for mAb-SARS-CoV-2 spike linked to VS-PEI. The biointerface showed good specificity against SARS-CoV-2 S1. Association (kₐₛₛ=6.74×10³ (M)⁻¹s⁻¹) and dissociation (k_{diss}=3.26×10⁻⁴ s⁻¹) kinetic constants and K_{D} were estimated by time-resolved binding curves (FIG. 26c) inset). The obtained K_{D} value was 48.4 nM.

For the case of the mAb-FTH1 biointerface (FIG. 26c)), human ferritin showed high affinity with the substrate, while no-recognition was observed for a sensor modified with BSA, as a control. From the time-resolved binding curves (FIG. 26c) inset), a K_{D} value of 2.54 nM was estimated.

Finally, the regeneration of the mAb recognition sites was studied by incubation in glycine 10 mM pH=2. FIG. 26d) displays the SPR response obtained for a 13.07 nM SARS-CoV-2 S1 solution after regenerating the surface. The regeneration/recognition protocol was repeated three times. It is evidenced that there was a good recovery of the mAb-coated sensor and reproducibility of the Ag-Ab affinity. This regeneration ability was also obtained for mAb-FTH1 anchored to VS-PEI.

### Example 3—Quantification of Urea

The rGO-FET sensor obtained in Example 1, together with the FETmeter and the algorithm that calculates the target analyte concentration, was used to set up a system as provided by the invention to determine the urea concentration in a solution.

In this example, interfacial nanoarchitectures were made from the polycation PEI and the enzyme urease prepared onto rGO-FETs by the layer-by-layer nanoconstruction technique. First, the rGO-FETs were submerged into a solution of 1-pyrenesulfonate, in dimethylformamide (DMF) at a concentration of 3 mM. A polyelectrolyte was then assembled by submerging the rGO-FET into a solution of polyethyleneimine (PEI) at a concentration of 2 mg/mL at pH 8.5 for about 10 minutes, with subsequent washing using distilled water. The rGO-FET modified with the polyelectrolyte was then submerged into a solution comprising urease as a recognition element for 30 min and washed with distilled water. The urease concentration was 1 mg/mL. This step promotes the adsorption of the recognition element onto the rGO surface.

These last steps, using the polyelectrolyte and enzyme, were repeated in alternation three times to increase the surface concentration of the recognition element. The nanoarchitecture was finished with a PEI outermost layer. By means if this nanoarchitecture, the urea sensors had an improved sensitivity obtained by an unexpected synergy between the polymer-enzyme nanoarchitecture and the rGO-FET sensor. In this case, the PEI polyelectrolyte contains weak-bases as functional groups that decrease their positive charge as the urea catalysis proceeds, resulting in an amplification of the field-effect response.

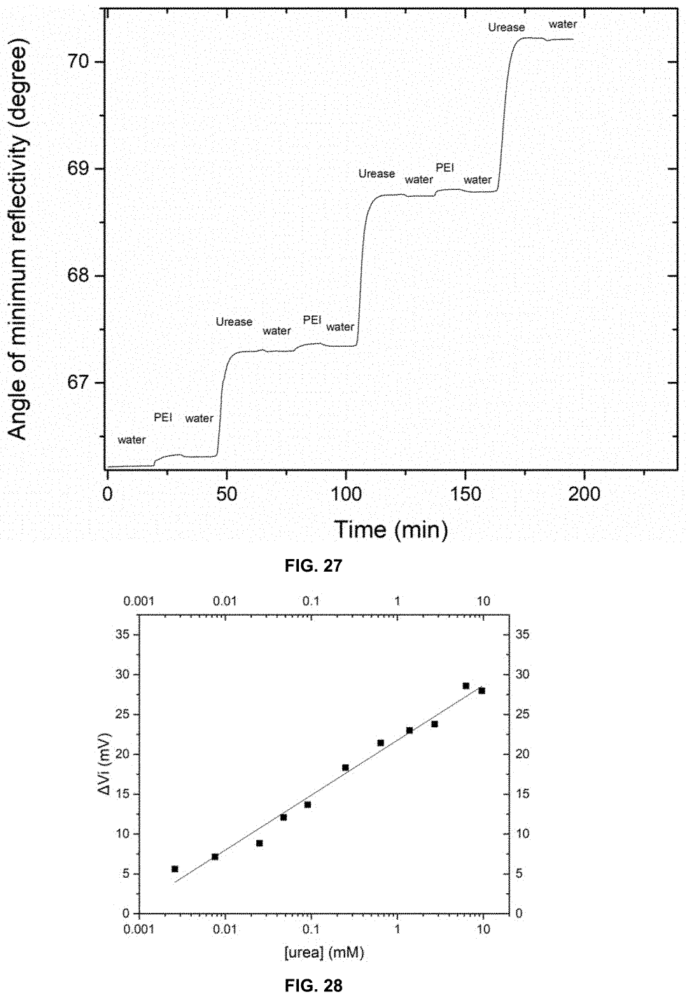

Surface plasmon resonance (SPR) experiments were performed to demonstrate the nanoconstruction of the PEI/Urease multilayer nanoarchitecture, as illustrated in FIG. 27. These measurements were made by using solutions of 2 mg/mL PEI at pH 8.5 and 1 mg/mL Urease in 10 mM NaCl 10 mM HEPES at pH 7.4. These SPR results evidence the modification of the rGO-FET with PEI and Urease with a nano-scale precision. Each PEI layer showed a thickness of approximately 2 nm, while the Urease layer showed a thickness of approximately 8 nm. Therefore, a three bilayer PEI/Urease multilayer presented a film thickness of 30 nm approximately.

The urea response of the sensor prepared with the nanoarchitecture onto the rGO-FET was monitored for different urea concentrations. Results are shown in FIG. 28, which shows the Dirac point (ΔVᵢ) as a function of the urea concentration in logarithmic scale for a urea biosensor, and its respective linear fit (solid line). The measurements were made in 1 mM KH₂PO₄, 3 mM KCl mM and 137 mM NaCl mM solutions. The voltage between drain and source (ΔV_{ds}) was 100 mV and a 10 mV/s scan rate was used.

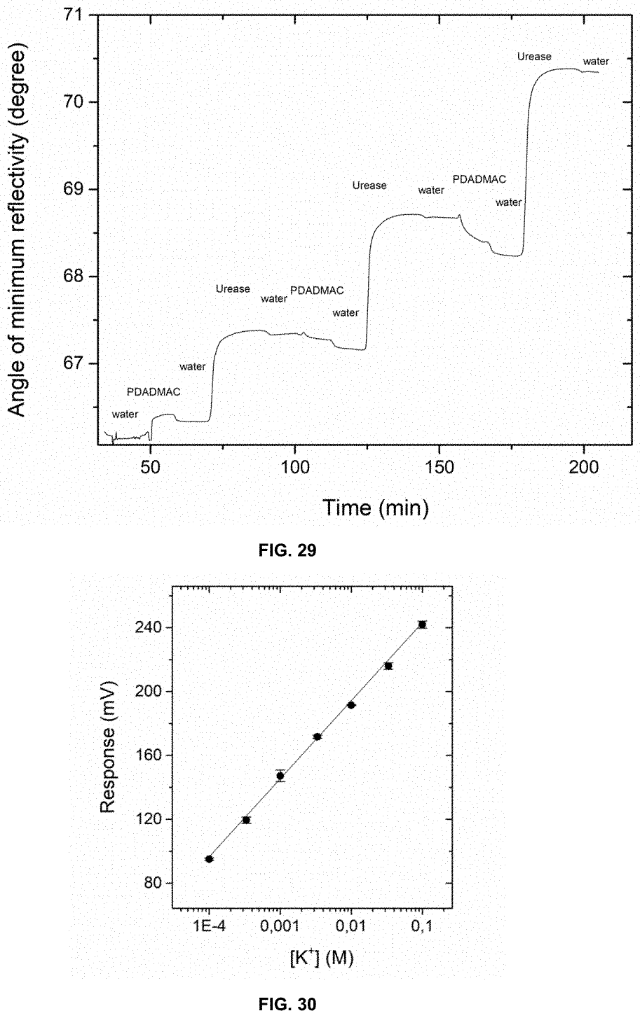

Other nanoarchitectures prepared onto the rGO-FET were studied by Surface plasmon resonance (SPR), for example the construction of a PDADMAC/Urease multilayer nanoarchitecture as illustrated in FIG. 29. Solutions of 1 mg/mL PDADMAC in 0.1 M NaCl and 1 mg/mL Urease in 10 mM NaCL 10 mM HEPES pH 7.4 were used. These SPR results evidence the modification of the rGO-FET with PDADMAC and Urease with a nano-scale precision. This nanoarchitecture was also suitable for the determination of urea levels in solution.

### Example 4—Quantification of Potassium

The rGO-FET sensor obtained in Example 1, together with the FETmeter and the algorithm that calculates the target analyte concentration, was used to set up a system as provided by the invention to determine the potassium concentration in solution.

In this example, the nanoarchitecture comprising the recognition element was obtained by modifying the graphene channel or the gate electrode of the rGO-FET with a coating comprising an ion-selective membrane. The ion selective membrane comprised a combination of an ionophore as the recognition element, a hydrophobic electrolyte, a plasticizer and a high molecular weight hydrophobic polymer as the structural element. We prepared an ion-selective cocktail by dissolving 660 mg of o-NPOE (65.88%), 330 mg of PVC (33%), 10 mg of potassium ionophore I, also named valinomycin, (1%), and 2.23 mg of KTPCIB (0.22%) in 2.5 mL of Tetrahydrofuran (THF). Then, 100 μL of the ion-selective cocktail was drop-casted onto the graphene channel.

FIG. 30 shows the potassium-response (ΔV as a function of the potassium concentration in logarithmic scale) for a potassium sensor connected to the FETmeter, and its respective linear fit (solid line).

### Example 5—Quantification of Ferritin

### 5.a) Preparation of a Ferritin Rapid Immunosensor

The biorecognition platforms were prepared as follows:
1) Graphene transistors were immersed in a 5 mM 1-pyrenebuthanoic acid succinimidyl ester (PBSE) in dimethylformamide (DMF) solution for 2 h. Then, the transistors were subsequently rinsed with DMF and dried with N₂.
2) A 2 mg/ml polyethilenimine (PEI) in Milli-Q water pH 10 solution was drop-casted for 1 h on the PBSE modified-gFETs. Afterward, they were rinsed with deionized water and dried with N₂.
3) In order to obtain the vinylsulfonated-polyamines (VS-PA) scaffolds, a 5% divinylsulfone (DVS, V3700, Sigma Aldrich) in carbonate buffer (0.5 M Na₂CO₃) pH 11 solution was drop-casted for 1 h on the array area of the transistors. Then, they were rinsed with deionized water and dried with N₂.
4) Later, a 100 ug/ml Ferritin monoclonal antibody in BBS pH 9 buffer solution was drop-casted for 1.5 h on the array area of the gFETs. The transistors were subsequently rinsed with BBS solution and dried with N₂.
5) Then, a 0.2 mM PEG-NH₂ (10 kDa) in BBS pH 9 solution was drop casted on the array area of the modified-gFETs for 2 h. The transistors were subsequently rinsed with PBS solution and dried with N₂.
6) Later, a 100 mM ethanolamine in BBS (pH 9) solution was drop casted on the array area for 15 minutes. Finally, the transistors were washed with BBS and stored in buffer solution.

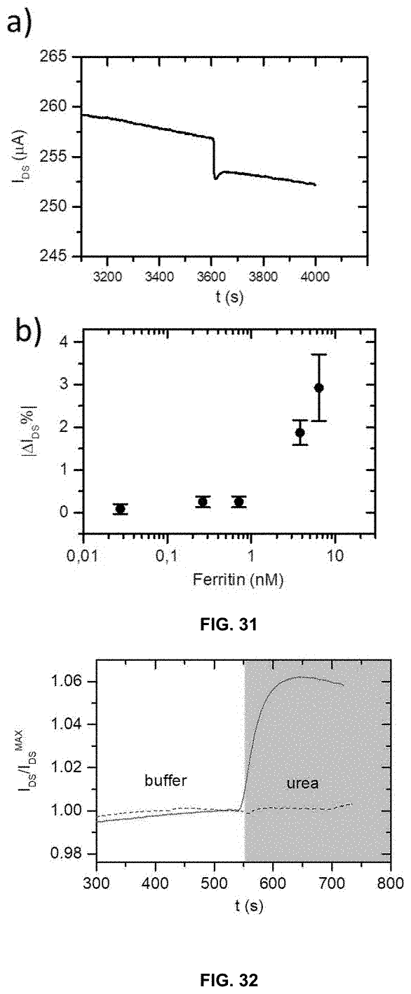

The measurements were performed employing an electrolyte-gated setup in HEPES 1 mM, NaCl 10 mM, CaCl₂ 0.05 mM, pH 7.4 buffer solution. The I_{DS} current was registered while both V_{DS} and V_{GS} were fixed at 100 mV and −250 mV respectively. The cell was filled with 200 μL buffer solution and the measurements were started. Volumes of different Ferritin concentration solutions prepared in the same buffer were added to the cell to reach the final Ferritin concentration. The accumulative relative drain-source current change (|%ΔI_{DS}|) was calculated by computing the difference between the current values immediately before and after the injection of the analyte solution. The curves obtained are illustrated in FIG. 31.

In FIG. 31b) it can be seen that the device shows changes in I_{DS} in the 0.1-100 nM region, ascribed to the binding of Ferritin to the antibody attached to the VS-PA nanoscaffold. The recognition and binding of Ferritin by the antibody is observed as a decrease in I_{DS}, coherent with negatively charged species adsorption, i.e., a p-doping effect (ferritin has negative charges at the pH employed, as its isoelectric point is 5.5).

### 5.b) Preparation of a Ferritin Indirect Immunosensor

The biorecognition platforms were prepared as follows:
1) Graphene sensors modified with VS-PA, Ferritin monoclonal antibody and PEG-NH₂ were incubated in a sample with Ferritin and rinsed.
2) Biosensors were then incubated in: i) a solution of secondary antibody modified with an enzyme, or, ii) a solution of biotinylated ferritin secondary antibody followed by incubation in solution of streptavidin modified with an enzyme, or iii) a solution of biotinylated ferritin secondary antibody, followed by incubation in a solution of streptavidin, and finally incubated in a solution of biotinylated enzyme.
3) The response is measured in the presence of the substrate for the chosen enzyme. For instance, the enzyme urease and the substrate urea can be used in this approach.

The drain-source current was registered while applying both fixed V_{DS}=50 mV and V_{GS}=−250 mV and the enzyme urease was used to reveal the presence of ferritin. If the sample contained human ferritin (solid line in FIG. 32), a current increase is observed by the addition of urea. Due to this enzyme-linked immunoassay approach, the presence of ferritin on the surface implies the presence of urease. Thus, when adding solution containing urea, the hydrolysis reaction catalyzed by urease leads to an increase in the pH of the solution which induces an increase in the current read, due to graphene p-doping. Thus, this method is based on graphene doping induced by enzyme-linked immunoassay (GELIA). With reference to FIG. 32, the solid line represents the response of a ferritin GELIA biosensor obtained for a sample with human ferritin, the dashed line represents the response of a ferritin GELIA biosensor obtained for a sample in the absence of human ferritin.

### Example 6—SARS-CoV-2 Spike Protein Rapid Immunosensor

The biorecognition platforms were prepared as follows:
1) Graphene transistors were immersed in a 5 mM 1-pyrenebuthanoic acid succinimidyl ester (PBSE) in dimethylformamide (DMF) solution for 2 h. Then, the transistors were subsequently rinsed with DMF and dried with N₂.
2) A 2 mg/ml polyethilenimine (PEI) in Milli-Q water pH 10 solution was drop-casted for 1 h on the PBSE modified-gFETs. Afterward, they were rinsed with deionized water and dried with N₂.
3) In order to obtain the vinylsulfonated-polyamines (VS-PA) scaffolds, a 5% divinylsulfone (DVS, V3700, Sigma Aldrich) in carbonate buffer (0.5 M Na₂CO₃) pH 11 solution was drop-casted for 1 h on the array area of the transistors. Then, they were rinsed with deionized water and dried with N₂.
4) Later, a 100 ug/ml SARS-CoV-2 Spike Protein Monoclonal Antibody (mAb) in BBS pH 9 buffer solution was drop-casted for 1.5 h on the array area of the gFETs. The transistors were subsequently rinsed with BBS solution and dried with N₂.
5) Then, a 0.2 mM PEG-NH₂ (10 kDa) in BBS pH 9 solution was drop casted on the array area of the modified-gFETs for 2 h. The transistors were subsequently rinsed with PBS solution and dried with N₂.
6) Later, a 100 mM ethanolamine in BBS (pH 9) solution was drop casted on the array area for 15 minutes. Finally, the transistors were washed with BBS and stored in buffer solution.

The measurements were performed employing an electrolyte-gated setup in PBS pH 7.4×0.1 (×0.1 implies a 1/10 dilution) buffer solution. The I_{DS} current was registered while both V_{DS} and V_{GS} were fixed at 100 mV and −250 mV respectively. The cell was filled with 200 μL buffer solution and the measurements were started. Volumes of different Spike concentration solutions prepared in the same buffer were added to the cell to reach the final Spike concentration. The accumulative relative drain-source current change (%ΔI_{DS}) was calculated by computing the difference between the current values immediately before and after the injection of the analyte solution.

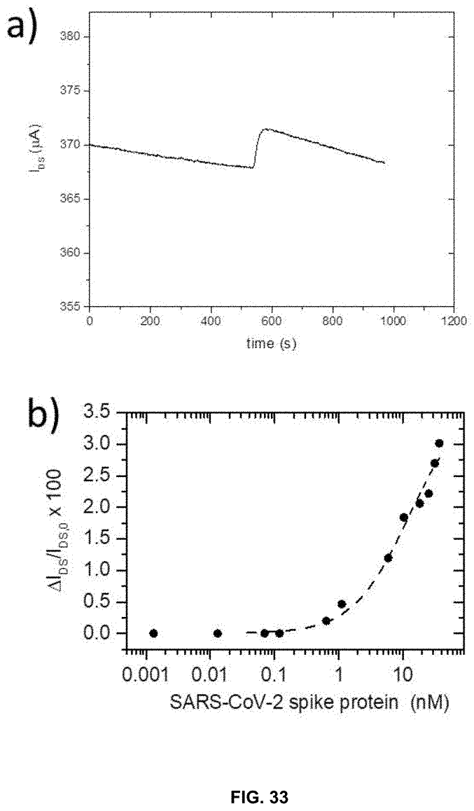

In FIG. 33, it can be seen that the device shows changes in I_{DS} in the 0.1-100 nM region, ascribed to the binding of the Spike protein to the mAb. The recognition and binding of the Spike protein by the antibody is observed as an increase in I_{DS}. This low detection limit of the developed biosensors would allow the determination of the protein (and therefore the disease in a patient), endowing the fast detection of the biomarker in seconds/minutes.

Moreover, the dashed line in FIG. 33b) is the best fit of the data for the estimation of the equilibrium dissociation constant (K_{D}) between the mAb and the SARS-CoV-2 spike protein, from the field-effect changes observed by the device. A K_{D} value of 11 nM was calculated.

1. A sensor comprising:
a field-effect transistor comprising semiconducting two-dimensional nanosheets, a gate electrode, a drain electrode, a source electrode and an interfacial nanoarchitecture, the interfacial nanoarchitecture comprising
a recognition element,
a structural element, and
a polymeric coating,
wherein the gate electrode of the transistor is coplanar with the drain electrode and the source electrode of the transistor.

2. The sensor of claim 1, wherein the semiconducting two-dimensional nanosheets are made of a substance selected from graphene, reduced graphene oxide, few-layer graphene, twisted bilayer graphene, conducting polymers, transition metal dichalcogenides, black phosphorous, and hexagonal boron nitride.

3. The sensor of claim 1, wherein the recognition element is immobilized by the structural element at a distance of up to 100 nm from a semiconducting nanosheet surface of the transistor.

4. The sensor of claim 1, wherein the structural element is attached to a semiconducting nanosheet surface of the transistor by one or more supramolecular binding-points.

5. The sensor of claim 1, wherein the source and drain electrodes of the transistor are interdigitated electrodes.

6. The sensor of claim 1, wherein the electrodes are made of a conductive material selected from gold, platinum, graphite, silver, conducting polymers and combinations thereof.

7. The sensor of claim 1, wherein the gate electrode is made of a conductive material selected from gold, platinum, graphite, silver, conducting polymers and combinations thereof and comprises a coating of Ag/AgCl.

8. The sensor of claim 1, wherein the recognition element is a substance selected from an enzyme, an antibody, an aptamer, clustered regularly interspaced short palindromic repeats (CRISPR) with a CRISPR associated protein (Cas), an ion-selective molecule, a high-affinity binding-protein, and combinations thereof.

9. The sensor of claim 8, wherein the substance is selected from urease, acetylcholinesterase, creatinine deiminase, streptavidin, avidin, valinomycin, tridodecylamine, an antibody or aptamer capable of binding an analyte selected from the group consisting of ferritin, Interleukin 6 (IL-6), SARS-CoV-2 spike protein, SARS-CoV-2 nucleocapsid (N) protein, follicle-stimulating hormone (FSH), anti-Mullerian hormone (AMH), estradiol, Luteinizing hormone (LH), fragments thereof, and modified fragments thereof.

10. The sensor of claim 1, wherein the structural element comprises a substance selected from a polyelectrolyte, a polymer, a cross-linker, a heterofunctional nanoscaffold and combinations thereof.

11. The sensor of claim 10, wherein the heterofunctional nanoscaffold comprises a substance selected from vinylsulfonated-polyamine (VS-PA), streptavidin, avidin and combinations thereof.

12. The sensor of claim 1, wherein the polymeric coating comprises a substance selected from polyethylene-glycol (PEG), a polyethylene-glycol derivatized polymer, a substance comprising polyethylene-glycol, a zwitterionic polymer, a fluoropolymer, a hydrogel and combinations thereof.

13. A system comprising:
a sensor according to claim 1 and a receptacle for receiving a liquid sample,
a power source connected to the sensor for establishing a voltage between the gate, drain and source electrodes of the sensor,
processing means for processing data connected to the sensor,
wherein the processing means for processing data comprise calculating means for calculating a concentration of a target analyte in the liquid sample.

14. The system of claim 13, wherein the calculating means for calculating the concentration comprise an algorithm for processing a sensor response.

15. The system of claim 14, wherein the calculating means for calculating the concentration further comprise eliminating means for eliminating interfering signals.

16. The system of claim 13, further comprising an interface for displaying the value of the concentration of the target analyte in the liquid sample.

17. A method for preparing a sensor comprising field-effect transistors, the method comprising the steps of:
providing a solution comprising a semiconducting material in two-dimensional nanosheets,
providing a field-effect transistor comprising a substrate and interdigitated drain and source electrodes,
depositing the solution onto a substrate surface,
providing a gate electrode coplanar with the interdigitated drain and source electrodes, and
providing the sensor surface with an interfacial nanoarchitecture comprising a recognition element, a structural element and a polymeric coating.

18. (canceled)

19. (canceled)

20. (canceled)
